(19) United States
(12) Patent Application Publication
(10) Pub. No.: US 2024/0333854 A1
(43) Pub. Date: Oct. 3, 2024

(54) IMAGE READING APPARATUS

(71) Applicant: CANON KABUSHIKI KAISHA, Tokyo (JP)

(72) Inventor: KAZUKI MATSUO, Kanagawa (JP)

(21) Appl. No.: 18/613,025

(22) Filed: Mar. 21, 2024

(30) Foreign Application Priority Data
Mar. 31, 2023 (JP) 2023-057732

(51) Int. Cl. H04N 1/00

(52) U.S. Cl. CPC H04N 1/00994; H04N 1/00594; H04N 1/0083

(57) ABSTRACT

Provided is a technique for eliminating or reducing the effect of a noise on a signal. An image reading apparatus includes: a conveyance unit configured to convey a document in a conveyance direction through a conveyance route; a first reading unit configured to read an image on the document conveyed by the conveyance unit; a cable routed on one side of the first reading unit and connected to the first reading unit; and a driving unit that is disposed on another side of the first reading unit and drives the conveyance unit.

### BACKGROUND OF THE INVENTION

### Field of the Invention

The present invention relates to an image reading apparatus capable of reading an image of a document.

### Description of the Related Art

An image reading apparatus including a flatbed scanner and an automatic document feeder (hereinafter referred to as “ADF”) has heretofore been known. To read a document with the ADF, the flatbed scanner's reading sensor is used to read one surface of the document, while a reading sensor disposed inside the ADF is used to read the other surface of the document. The reading sensor disposed inside the ADF is connected to the flatbed scanner by a signal cable that has a function of supplying motive power and other similar functions.

In Japanese Patent Laid-Open No. 2015-023310, a signal cable is disposed through the inside of a document tray in an ADF, led out from the back side of the ADF where a driving motor is disposed, and connected to a main body.

Here, in the technique disclosed in Japanese Patent Laid-Open No. 2015-023310, the signal cable is routed to the back side of the ADF where the driving motor is disposed. For this reason, the signal cable passes near the motor. A noise originating from the driving of the motor imposes an effect on the signals transferred through the signal cable. This leads to a possibility of image defects occurring in reading results due to the effect.

### SUMMARY OF THE INVENTION

The present invention has been made in view of the above problem and provides a technique for eliminating or reducing the effect of a noise on a signal.

In the first aspect of the present invention, there is provided an image reading apparatus including:
a conveyance unit configured to convey a document in a conveyance direction through a conveyance route;
a first reading unit configured to read an image on the document conveyed by the conveyance unit;
a cable routed on one side of the first reading unit and connected to the first reading unit; and
a driving unit that is disposed on another side of the first reading unit and drives the conveyance unit.

In accordance with the present invention, it is possible to eliminate or reduce the effect of a noise on a signal.

Further features of the present invention will become apparent from the following description of exemplary embodiments with reference to the attached drawings.

### BRIEF DESCRIPTION OF THE DRAWINGS

FIGS. 1A and 1B are exterior views of an image reading apparatus;

FIG. 2 is a cross-sectional view of the image reading apparatus;

FIGS. 3A and 3B are schematic views of a configuration of an image reading part;

FIGS. 4A and 4B are schematic views of a configuration of an ADF;

FIG. 5 is a side view of the image reading apparatus;

FIG. 6 is a plan view of the image reading apparatus;

FIG. 7 is an enlarged perspective view of the image reading apparatus centered at an opening portion of the ADF;

FIGS. 8A and 8B are views explaining a configuration of a sub tray for a sliding movement;

FIGS. 9A and 9B are views explaining a configuration of a housing for the sliding movement;

FIGS. 10A to 10E are views explaining a movement of the sub tray between a first position and a second position;

FIGS. 11A to 11C are views illustrating the positional relationship between a retaining portion and a pressing portion in a first position and positions near it;

FIGS. 12A and 12B are perspective views of a platen;

FIGS. 13A to 13C are cross-sectional views of a main section of the platen;

FIG. 14 is a schematic view of a configuration of a back surface reading unit;

FIG. 15 is a view illustrating the positions on a main frame where a signal cable and a driving motor are disposed;

FIGS. 16A and 16B are plan views of a main frame unit;

FIG. 17 is a perspective view of the main frame unit;

FIG. 18 is a view illustrating the inside of the housing in which the main frame unit disposed;

FIG. 19 is a view illustrating a modification of the arrangement of the signal cable; and

FIG. 20 is a view illustrating a modification of the arrangement of the signal cable.

### DESCRIPTION OF THE EMBODIMENTS

An example of an embodiment of an image reading apparatus will be described below with reference to the accompanying drawings. Note that the following embodiment does not limit the present invention, and not all the combinations of the features described in this embodiment are necessarily essential for the solution to be provided by the present invention. Moreover, the positions, shapes, and the like of the constituent elements described in the embodiment are mere examples, and there is no intension to limit the present invention only to these.

### (Entire Configuration of Image Reading Apparatus)

In the present embodiment, an image reading apparatus capable of reading an image of a document conveyed by an automatic document conveyance apparatus (hereinafter referred to as “ADF”) and forming an image on a sheet will be described as an example. In the following description, to “read an image of a document” will also be expressed simply as to “read a document”. The technique disclosed in the present embodiment is not limited only to the image reading apparatus to be described below but is applicable also to copiers, facsimiles, multi-function peripherals, and the like combining a flatbed scanner apparatus and an image reading apparatus. In the present embodiment, “sheet” includes publicly known media on which images can be formed with a liquid such as ink, including plain paper, special paper such as coated paper, print materials with special shapes such as envelopes and index paper, plastic films, fabrics, and so on. Note that a document is also an example of the sheet.

The directions used in the present embodiment will be represented as directions in the view of the user facing the front of the image reading apparatus at the time of using it, and will be represented using X, Y, and Z directions perpendicular to one another. Specifically, the X, Y, and Z directions are the left-right, front-rear, and up-down directions, respectively. In the drawings, the X direction is illustrated as a direction from the left to the right, the Y direction is illustrated as a direction from the front (near side) toward the back (far side), and the Z direction is illustrated as a direction from the bottom toward the top.

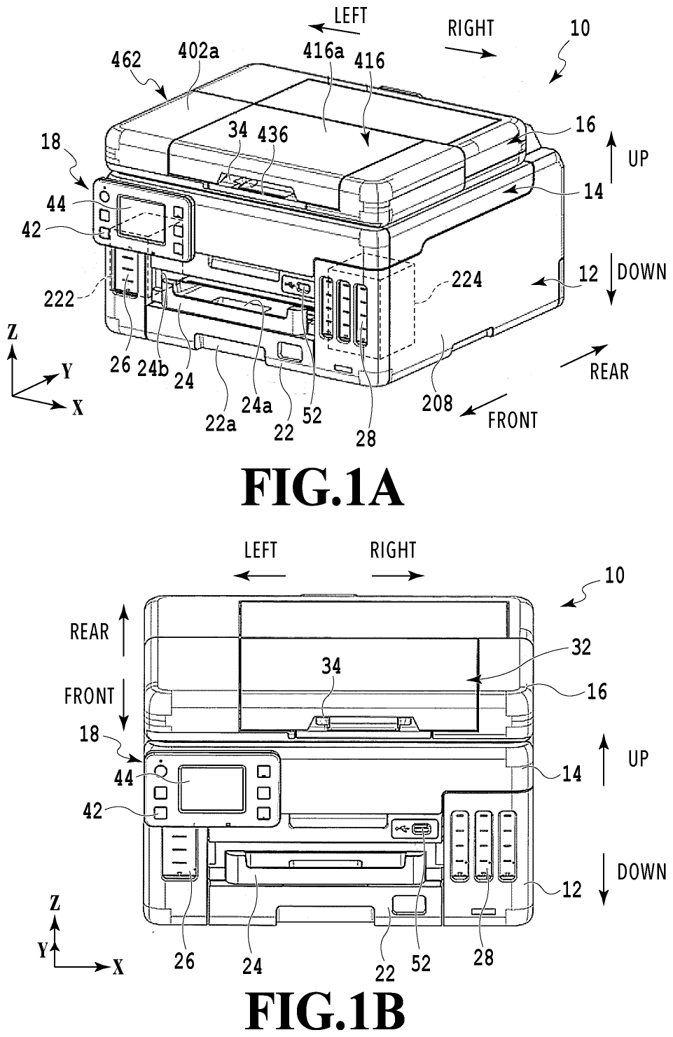

FIGS. 1A and 1B are exterior views of the image reading apparatus. FIG. 1A is a perspective view, and FIG. 1B is a front view slightly obliquely from above. An image reading apparatus 10 includes an image forming part 12 capable of forming a full-color image on a sheet, an image reading part 14 capable of reading an image of a document, and an ADF 16 capable of conveying the document whose image is to be read by the image reading part 14. In the image reading apparatus 10, the image reading part 14 is disposed on the image forming part 12, and the ADF 16 is disposed on the image reading part 14. Specifically, in the image reading apparatus 10, the image forming part 12, the image reading part 14, and the ADF 16 are arranged in this order in the Z direction. The image reading apparatus 10 also includes an operation panel 18 on which the user can input operations and which is capable of notifying the user of various information.

The image forming part 12 includes a cassette 22 which houses sheets before image forming, and a discharge tray 24 which is arranged on the cassette 22 and onto which sheets after image forming are discharged. The cassette 22 is arranged in the front (front surface) of the image forming part 12 (image reading apparatus 10) so as to be capable of being inserted and drawn. As will be described later in detail, some of the constituent elements of the discharge tray 24 are configured to be capable of being drawn toward the front side.

In the present embodiment, the cassette 22 and the discharge tray 24 are each disposed with its center position in the X direction (left-right direction) offset from the center position of the image forming part 12 toward the left, but are not limited to this arrangement. Specifically, the cassette 22 and the discharge tray 24 may each be disposed to be offset toward the right according to the sizes of other constituent elements and the positions where they are disposed. Alternatively, the cassette 22 and the discharge tray 24 may each be disposed with its center position set at a position coinciding with the center position of the image forming part 12.

The image forming part 12 includes ink tanks 222 and 224 storing inks serving as printing agents on both sides of the cassette 22 and the discharge tray 24 in the X direction. Moreover, the image forming part 12 includes remaining amount display portions 26 and 28 which display the remaining amounts of the inks in the ink tanks at positions in the front of the image forming part 12 corresponding to the ink tanks. The remaining amount display portions 26 and 28 may be windows through which the remaining amounts of the inks in the respective ink tanks can be visually recognized, or display screens which display images corresponding to the remaining amounts. The configuration may be such that the ink tanks 222 and 224 are disposed on the opposite sides in the left-right direction or disposed together on the right or left.

In the present embodiment, the image reading apparatus 10 is capable of forming full-color images. Thus, the ink tank 222 located on the left stores a black ink. The ink tank 224 located on the right separately stores cyan, magenta, and yellow inks. Thus, the remaining amount display portion 26 displays the remaining amount of the black ink while the remaining amount display portion 28 displays the remaining amounts of the cyan, magenta, and yellow inks. In the present embodiment, a configuration using four types of inks is employed. However, the configuration is not limited to this one and a configuration using one to three or five or more types of inks may be employed, and/or a configuration using a liquid such as a process liquid for performing a predetermined process on inks ejected onto a sheet may be employed.

The image forming part 12 includes a universal serial bus (USB) terminal 52 connectible to an external apparatus, such as a personal computer. In the present embodiment, the USB terminal 52 is provided in the front of the image forming part 12 in order to improve the user operability. This USB terminal 52 may be provided in a side surface (right or left side surface) or the back surface (rear surface) of the image forming part 12.

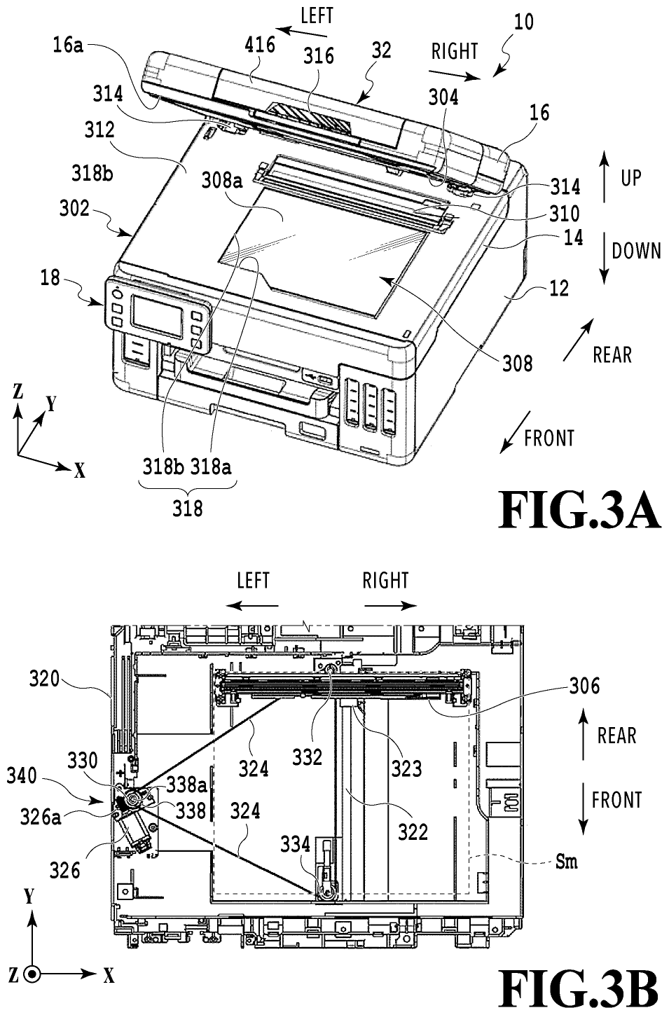

The image reading part 14 includes a reading unit 306 (see FIG. 3B) that images on a document conveyed by the ADF 16 and a document placed on a platen glass 308 (described later). The ADF 16 includes a document feed tray 32 on which to place documents whose images are to be read, and a document discharge tray 34 on which to discharge documents whose images have been read. In the present embodiment, the document feed tray 32 and the document discharge tray 34 are each provided with its center position in the X direction offset from the center position of the image reading part 14 (image reading apparatus 10) toward the right.

The operation panel 18 is disposed at a height position which is on the left of the front of the image reading apparatus 10 and at which the image reading part 14 is disposed. In the present embodiment, the operation panel 18 is disposed at such a position that the left side surface of the operation panel 18 and the left side surface of the image reading apparatus 10 substantially coincide with each other in the X direction. The operation panel 18 may be disposed on the right of the front of the image reading apparatus 10. In sum, the operation panel 18 may be disposed on the left or right so as not to stick out of the image reading apparatus 10 in the X direction. The operation panel 18 includes physical switches 42, such as a start button, and a display part 44 capable of displaying various information and inputting information by touch operations, such as a touch panel.

### (Configuration of Image Forming Part)

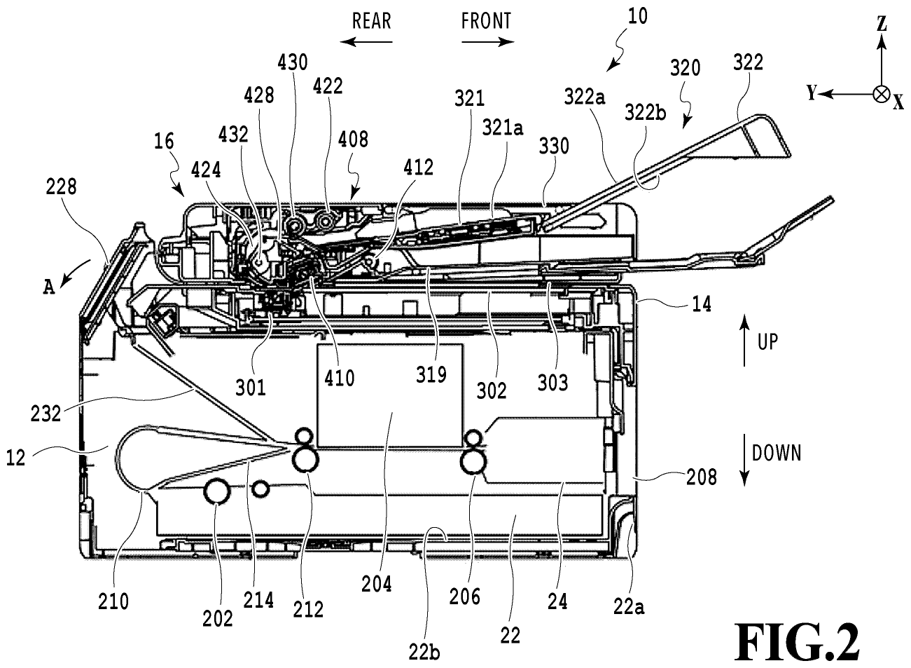

Next, a configuration of the image forming part 12 will be described in detail with reference to FIG. 2. FIG. 2 is a cross-sectional view of the image reading apparatus 10 taken substantially at its center position in the X direction. In FIG. 2, the document feed tray 32 and the document discharge tray 34 are illustrated in a state of being drawn. Also, in FIG. 2, the configuration of the image forming part 12 is illustrated in a simplified fashion to facilitate understanding.

The image forming part 12 includes a pickup roller 202 that feeds a sheet housed in the cassette 22, and a printing part 204 that performs printing on the sheet fed and transferred by the pickup roller 202 by ejecting the inks on this sheet to form an image on it. The image forming part 12 also includes a discharge roller 206 that discharges the sheet on which an image has been formed by the printing part 204 onto the discharge tray 24. The image forming part 12 also includes a control part (not illustrated) that controls the entire operation of the image reading apparatus 10.

The cassette 22 houses multiple sheets therein in a stacked state. The cassette 22 is configured to be capable of being inserted into and drawn from a housing 208 of the image forming part 12. To house sheets into the cassette 22, the user grips a gripping portion 22a provided in the front surface of the cassette 22 and pulls the cassette 22 toward the front side. The user then houses multiple sheets in a stacked state into the cassette 22 and thereafter inserts the cassette 22 into a housing portion 22b formed in the housing 208 and pushes in the cassette 22 toward the rear side to thereby insert the cassette 22 into the housing 208.

The pickup roller 202 feeds the top sheet among the sheets stacked in the cassette 22 inserted in the housing 208 to the printing part 204. Specifically, the sheet fed by the pickup roller 202 reaches a registration roller pair 212 through a conveyance path 210. The conveyance path 210 is formed in a substantially U-shape and causes the sheet fed from the front side toward the rear side to make a U-turn through the curved portion to guide the sheet from the rear side toward the front side to the registration roller pair 212.

The image forming part 12 also includes a manual feed tray 228 on the rear side. The manual feed tray 228 is configured to be capable of pivoting between a retracted position (the position illustrated in FIG. 2) and a placement position in which sheets can be placed. The placement position can be reached by pivoting in the direction of the arrow A from the retracted position. Sheets placed on the manual feed tray 228 in the placement position are transferred by an auto sheet feeder (ASF) not illustrated. Each sheet transferred by the ASF reaches the registration roller pair 212 through a conveyance path 232. The manual feed tray 228 in the retracted position is located so as not to project from the rear surface or upper surface of the image reading apparatus 10.

Each sheet transferred to the registration roller pair 212 through the conveyance path 210 or 232 abuts the registration roller pair 212 in a state where its rotation is stopped. This corrects the skew of the transferred sheet. The registration roller pair 212 is rotated with image forming timing to convey the sheet to the printing part 204. In the present embodiment, the registration roller pair 212 (and the pickup roller 202) function as a sheet conveyance part that conveys sheets.

On an upstream side in the sheet conveyance direction of the registration roller pair 212, there is provided a reverse conveyance path 214 for reversing a sheet conveyed in the opposite direction to the above conveyance direction and transferring it to the printing part 204. In a case of forming images on both surfaces of a sheet, first, an image is formed on one surface of the sheet conveyed in the conveyance direction through the conveyance path 210 (the direction from the rear side toward the front side) with the printing part 204. Then, the sheet with the image formed on the one surface is conveyed in the opposite direction to the conveyance direction while the conveyance route is switched by a switching member (not illustrated) to guide the sheet to the reverse conveyance path 214. Thereafter, the sheet gets reversed through the reverse conveyance path 214 and reaches the registration roller pair 212 again, and an image is formed on the other surface of the sheet by the printing part 204.

The printing part 204 includes print heads (not illustrated) capable of ejecting inks by an ink jet method. A print head is provided for each type of ink, and ejects the ink onto a sheet conveyed through the registration roller pair 212 according to an image signal read by the image reading part 14 or an image signal input from an external apparatus. As a result, an image is formed on the sheet. In the present embodiment, the printing part 204 is, for example, a so-called serial scan-type printing part that performs printing while moving in the X direction crossing the Y direction, which is the sheet conveyance direction. The printing part 204 may be a so-called full line-type printing part including print heads in which ink ejection nozzles are provided at a region extending over the length of a printable sheet in the X direction. The printing method of the printing part 204 is not limited to the ink jet method. For example, a publicly known printing method such as an electrophotographic method using toners may be employed.

The printing part 204 is configured such that the print heads are reciprocally movable in the X direction by means of a carriage (not illustrated). The print heads mounted on the carriage are supplied with the inks stored in the ink tanks 222 and 224 through tubes (not illustrated). At the image forming part 12, after a conveyance operation of conveying a sheet by a predetermined amount in the Y direction with the registration roller pair 212, the print heads perform a print operation of performing printing on this sheet while moving in the X direction by means of the carriage. Thereafter, a conveyance operation is executed and then a print operation is executed again. At the image forming part 12, a conveyance operation and a print operation are alternately repeated as above under control of the control part (not illustrated) to thereby form an image on the sheet based on image data.

The discharge roller 206 discharges the sheet in the direction from the rear side toward the front side. In the vicinity of the front end of the discharge tray 24, a handhold portion 24a is formed which is open at its upper surface and on which the user can put a hand (see FIG. 1A). The user can put a hand on the handhold portion 24a and pull it toward the front side to draw the discharge tray 24 toward the front side. The user can push the discharge tray 24 drawn from the housing 208 toward the rear side to house it in a housing portion 24b provided in the housing 208 (see FIG. 1A).

### (Configuration of Image Reading Part)

Next, a configuration of the image reading part 14 will be described in detail. FIGS. 3A and 3B are views explaining the configuration of the image reading part 14. FIG. 3A is a perspective view the image reading apparatus 10 with the ADF 16 opened. FIG. 3B is a view illustrating an internal configuration of the image reading part 14. Note that FIG. 3B illustrates a state where the platen has been detached from the image reading part 14.

The image reading part 14 is pivotally provided on the top of the image forming part 12. To access the printing part 204 in the image forming part 12 or the like, the image reading part 14 is pivoted to be opened. The image reading part 14 includes a platen 302 on which a document to be read can be placed, a pressing plate portion 304 which holds the document placed on the platen 302, and the reading unit 306, which reads the image on the document through the platen 302.

### <Platen and Pressing Plate Portion>

The platen 302 includes the platen glass 308 and an ADF glass 310. A document is placed on the platen glass 308 with the surface on which an image to be read is drawn in abutment with the platen glass 308. The surface of a document on which an image is drawn is caused to pass the upper surface of an ADF glass 310 by the ADF 16. The platen glass 308 and the ADF glass 310 are made of colorless transparent glass and arranged next to each other along the Y direction inside a frame member 312. In the platen 302, the upper surfaces of the frame member 312, the platen glass 308, and the ADF glass 310 are located in substantially the same plane.

The frame member 312 includes a pair of hinge portions 314 with a pivotal shaft parallel to the X direction which are provided on the rear side relative to the platen glass 308 and the ADF glass 310. The ADF 16 is pivotally disposed on the frame member 312 with the hinge portions 314. Thus, in a case of placing a document on the platen glass 308, the ADF 16 is opened (see FIG. 3A) to expose the platen glass 308 to the outside. In a case of reading the document on the platen glass 308, the ADF 16 is closed (see FIG. 1A). In the state where the ADF 16 is closed, a bottom surface 16a of the ADF 16 is located on the platen 302. Thus, the pressing plate portion 304 is disposed at a predetermined position on the bottom surface 16a including a region facing the platen glass 308 in the state where the ADF 16 is closed. In this way, by closing the ADF 16, the pressing plate portion 304 holds a document placed on the platen glass 308.

In the front surface of the ADF 16, a gripping portion 316 is provided into which the user can insert fingers to grip the ADF 16 in a case of opening and closing the ADF 16. More specifically, the gripping portion 316 is a recessed portion formed in the front surface of the ADF 16 such that the user can insert a hand into the recessed portion and lift up the closed ADF 16 to pivot the ADF 16 into the open state. The user can also insert a hand into the gripping portion 316 and push down the open ADF 16 into the closed state. As will be described in detail later, the gripping portion 316 serves also as a gripping portion which the user grips in a case of drawing a sub tray 416 of the document feed tray 32.

In the present embodiment, the image reading part 14 is capable of executing a so-called feeding reading mode in which the reading unit 306 located at a reading position reads the image on a document while the ADF 16 conveys the document. The image reading part 14 is also capable of executing a so-called fixed reading mode in which a document is placed on the platen glass 308, and the reading unit 306 is moved with the document pressed against the platen glass 308 with the pressing plate portion 304 to read the image on the document.

In the present embodiment, the maximum size of a document from which an image can be read is different between the feeding reading mode and the fixed reading mode, but may be the same. For example, in the present embodiment, the maximum size of a document from which an image can be read is smaller in the fixed reading mode than in the feeding reading mode. Specifically, the maximum document size is A4 in the feeding reading mode while the maximum document size is A5 in the fixed reading mode, for example.

The upper surface of the platen glass 308 is a document placement surface 308a on which to place a document. Also, at the boundary between the platen glass 308 and the frame member 312, an abutment portion 318 is provided which edges of a document can abut on so that the document placed on the document placement surface 308a can be positioned. The abutment portion 318 includes a first abutment portion 318a extending in the X direction and a second abutment portion 318b extending in the Y direction. In this way, the abutment portion 318 allows a document to be positioned in the front-rear direction (Y direction) with the first abutment portion 318a and in the left-right direction (X direction) with the second abutment portion 318b. A specific configuration of the abutment portion 318 will be described later.

In a case of reading a document in the fixed reading mode, the reading unit 306, which is disposed under the platen glass 308 reads the image drawn on the surface of the document in abutment with the document placement surface 308a. At this time, the reading unit 306 needs to read the document's entire reading surface (the image-drawn surface in abutment with the document placement surface 308a) while moving in the Y direction. For this reason, the platen glass 308 is designed in such a size that the reading unit 306 can read the entire region of a document with the maximum readable size.

The ADF glass 310 is disposed on the rear side relative to the platen glass 308 in the Y direction. The position where this ADF glass 310 is disposed corresponds to the reading position at which the reading unit 306 is located in the feeding reading mode. Specifically, in the case of executing the feeding reading mode, the reading unit 306 moves upstream to the reading position at which the ADF glass 310 is located and, from this reading position, reads the image on a document conveyed over the ADF glass 310 by the ADF 16.

### <Reading Unit>

A contact image sensor (CIS), for example, is used as the reading unit 306. The CIS irradiates the image-drawn surface of a document with light from a light source, such as a light emitting diode (LED), and images the reflected light from the surface on a sensor element through a self-focusing rod lens array to read the image. The reading unit 306 is disposed so as to extend in the X direction.

The reading unit 306 is disposed below the platen glass 308 and the ADF glass 310 so as to be movable in the Y direction. In the feeding reading mode (in a case of reading a document conveyed by the ADF 16), the reading unit 306 moves to the reading position under the ADF glass 310 and stays at the reading position to read the image. On the other hand, in the fixed reading mode, the reading unit 306 reads the image while moving under the platen glass 308 in the Y direction from a reading start position for starting reading the document.

The reading unit 306 is disposed so as to extend in the X direction and be reciprocally movable in the Y direction. Also, the reading unit 306 is disposed inside a housing 320 of the image reading part 14 so as to be capable of reading documents on the platen glass 308 and the ADF glass 310. In sum, the reading unit 306 is capable of reciprocally moving under the platen glass 308 and the ADF glass 310 inside the image reading part 14 so as to be capable of reading documents through the platen glass 308 and the ADF glass 310. Note that the reading unit 306 has such a length in its extending direction (X direction) as to be capable of reading a range having the length of the A4 size in its transverse direction, for example.

### <Movement Mechanism of Reading Unit>

The image reading part 14 has a configuration to reciprocally move the reading unit 306 in the Y direction inside the housing 320. Specifically, the image reading part 14 includes, as this configuration, a rail portion 322 extending in the Y direction and a carriage 323 supporting the reading unit 306 and slidably supported on the rail portion 322. The image reading part 14 also includes, as the configuration, a belt 324 for moving the carriage 323 and a driving motor 326 for actuating the belt 324.

The belt 324 is fixed at a portion thereof to the carriage 323, and transmits the driving force of the driving motor 326 to the carriage 323. With the driving force transmitted through the belt 324, the carriage 323 reciprocally moves the reading unit 306 supported thereon in the Y direction along the rail portion 322. Note that the carriage 323 is moved by the driving force of the driving motor 326 but maintains the posture of the reading unit 306, i.e., the state of extending in the X direction. A movement region Sm (see FIG. 3B) in which the reading unit 306 moves is a region covering the platen glass 308 and the ADF glass 310 in an XY plane.

The driving motor 326 is present outside the movement region Sm for the reading unit 306 and provided on one side relative to the movement region Sm in the X direction. In the present embodiment, the driving motor 326 is provided to the left of the movement region Sm. Specifically, in the present embodiment, the driving motor 326 is disposed at such a position as to overlap the operation panel 18 in the X direction, i.e., behind the operation panel 18. As will be described later in detail, in the present embodiment, the conveyance center of documents at the ADF 16 is offset toward the right from the center position of the image reading part 14 (image reading apparatus 10) in the X direction. For this reason, the center position of the movement region Sm is also offset toward the right from the center position of the image reading part 14 in the X direction. Accordingly, in the image reading part 14, a larger space is formed on the left side of the movement region Sm than on the right side. This is why the driving motor 326 (a driving unit 340 to be described later) is provided in the relatively wide space on the left. In sum, the driving motor 326 is disposed on the opposite side from the side toward which the conveyance center of documents at the ADF 16, i.e., the center position of the movement region Sm, is offset from the center position of the image reading part 14 in the X direction. This enables downsizing of the apparatus.

The belt 324 is loaded on three pulleys, namely, a driving pulley 330, a first pulley 332, and a second pulley 334, in a stretched state. The reading unit 306 is fixed to the belt 324 between the first and second pulleys. In this way, the reading unit 306 is configured to be reciprocally movable between the first and second pulleys 332 and 334 in response to actuation of the belt 324 by the driving motor 326.

The driving pulley 330 is a pulley which is disposed near the driving motor 326 and to which the drive of the driving motor 326 is transmitted. The driving pulley 330 is provided on an output shaft 338a of a speed reducer 338 that reduces and outputs the drive of a driving shaft 326a of the driving motor 326. In the present embodiment, the driving unit 340, which includes the driving motor 326, the driving pulley 330, and the speed reducer 338, is present outside the movement region Sm and provided at the left of the image reading part 14. By disposing the whole driving unit 340 outside the movement region Sm and at the left of the image reading part 14 as described above, the image reading part 14 is prevented from becoming large in size in the X direction. In sum, the driving unit 340 is disposed on the opposite side from the side toward which the center position of the movement region Sm for the reading unit 306 is offset from the center position of the image reading apparatus 10 in the X direction to effectively utilize the space in the image reading part 14.

The first pulley 332 is disposed on one side in the movement direction of the reading unit 306 (Y direction), more specifically, disposed rearward of the rear moving end of the reading unit 306 (i.e., the rear end of the movement region Sm). The ADF glass 310 is located rearward of the platen glass 308. Thus, in the feeding reading mode, the first pulley 332 is disposed rearward of the reading position for the reading unit 306. In other words, the first pulley 332 is disposed at such a position that the reading unit 306 can be located at the reading position. Incidentally, a configuration in which the reading unit 306 can be located rearward of the reading position may be employed by, for example, setting a home position rearward of the reading position. In this case, the position of the first pulley 332 also moves according to the rearmost position for the reading unit 306. The home position for the reading unit 306 is a position where the reading unit 306 is located in a standby period and the like during which no reading is performed.

The second pulley 334 is disposed on the other side in the movement direction of the reading unit 306, more specifically, disposed forward of the front moving end of the reading unit 306 (i.e., the front end of the movement region Sm). In the present embodiment, the home position for the reading unit 306 is the front end of the movement region Sm for the reading unit 306. Specifically, the home position for the reading unit 306 is set forward of the platen glass 308. Thus, in the present embodiment, the reading unit 306 needs to be located forward of the first abutment portion 318a under the platen glass 308. For this reason, the second pulley 334 is disposed forward of the position of the frontmost end of the reading unit 306 located at the home position. The first and pulleys 332 and 334 are disposed such that the belt 324 located between the first and second pulleys 332 and 334 extends substantially in the Y direction. The home position for the reading unit 306 is not limited to the position of the front end or rear end of the movement region Sm. For example, the home position may be set between the platen glass 308 and the ADF glass 310.

As described above, in the present embodiment, the driving unit 340 is located to the left of the movement region Sm, the first pulley 332 is located rearward of the movement region Sm, and the second pulley 334 is located forward of the movement region Sm. Accordingly, the belt 324 is stretched in a substantially triangular shape. Also, the belt 324 is substantially parallel to the rail portion 322 between the first and second pulleys 332 and 334, to which the reading unit 306 is fixed. Thus, the reading unit 306 supported on the carriage 323 reciprocally moves between the first and second pulleys 332 and 334 along the rail portion 322 in response to actuating the belt 324 by driving the driving motor 326. This makes it possible to move the reading unit 306 to the reading position in the feeding reading mode and move the reading unit 306 in the Y direction in the fixed reading mode.

In the present embodiment, the reading unit 306 is moved from the front side toward the rear side in the case of reading the image on a document placed on the platen glass 308, i.e., in the fixed reading mode. For this reason, in the present embodiment, the first abutment portion 318a for positioning a document in the Y direction is provided on the front side of the platen glass 308. Also, in the present embodiment, the home position for the reading unit 306 is set at the front end of the movement region Sm. This shortens the time it takes for the reading unit 306 to move from the home position to the reading start position before starting the fixed reading mode. The reading start position is a position at which the reading unit 306 starts reading a document placed on the platen glass 308. This position is located forward of the platen glass 308, and the reading unit 306 can be moved at a stable speed toward the rear side from the position. This configuration shortens the time lag from when the user gives an instruction to start reading in the fixed reading mode until when the reading unit 306 actually starts the reading. Incidentally, the reading unit 306 is moved from the home position to the reading position in the case of executing the feeding reading mode.

### (Configuration of ADF)

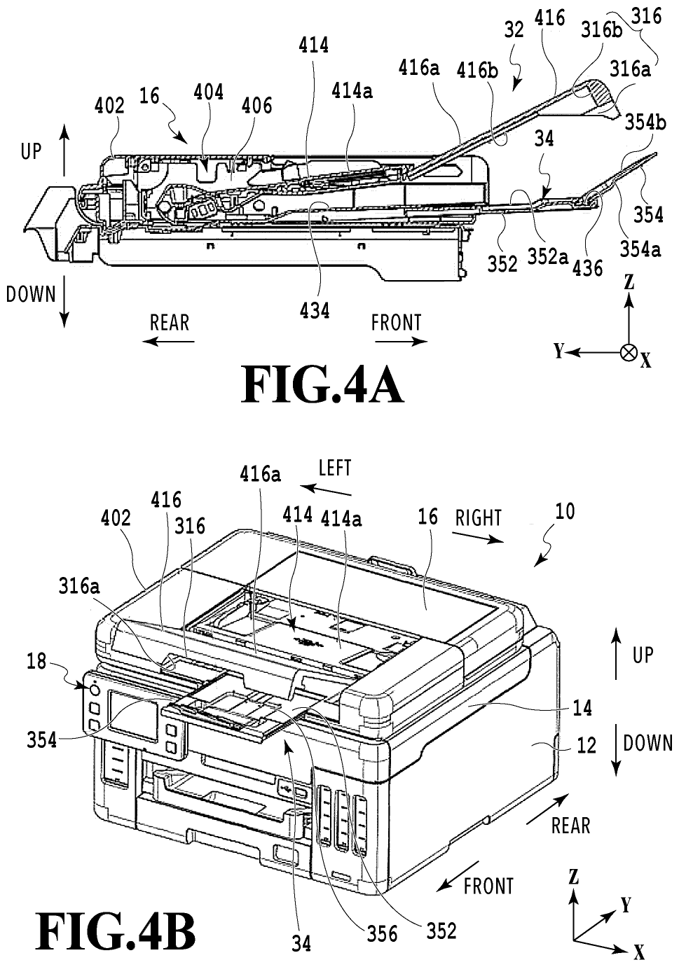

Next, a configuration of the ADF 16 will be described. FIGS. 4A and 4B are views explaining the configuration of the ADF 16. FIG. 4A is a cross-sectional view of the ADF 16 taken substantially at its center position in the X direction. FIG. 4B is a perspective view of the image reading apparatus 10 with the document feed tray 32 and the document discharge tray 34 extended. FIG. 4A is a cross-sectional view focusing a housing 402, a main frame 406, the document feed tray 32, and the document discharge tray 34.

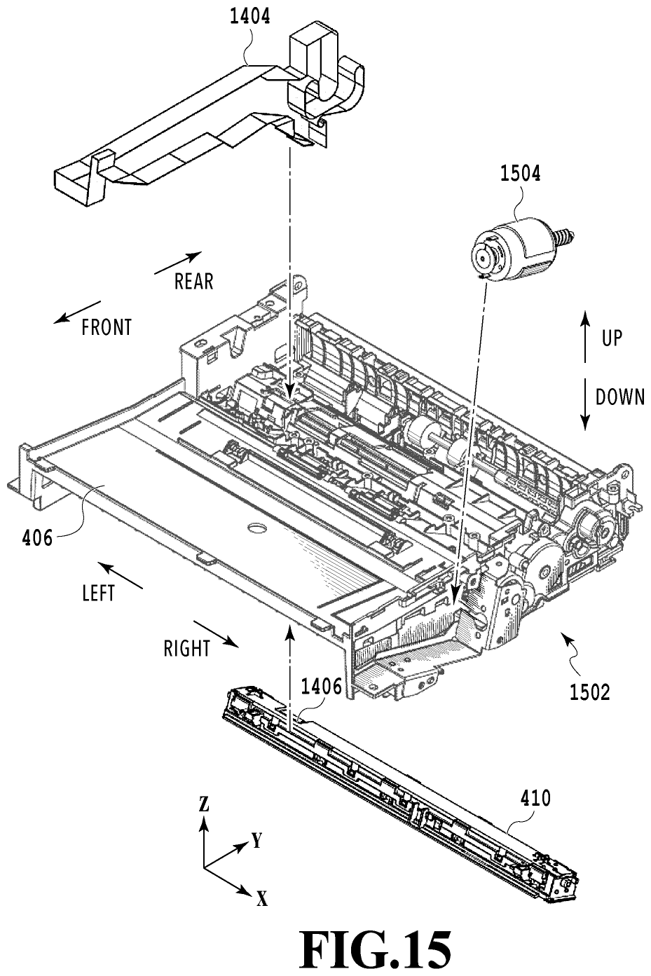

The ADF 16 includes a main frame unit 404 and the document discharge tray 34 in the housing 402, which includes the bottom surface 16a. The main frame unit 404 includes the main frame 406, the document feed tray 32 on which to place a document to be read, and a document feed part 408 (see FIG. 2) which feeds the document placed on the document feed tray 32. The main frame unit 404 also includes a back surface reading unit 410 (see FIG. 2) capable of reading the back surface of a fed document and a discharge roller 412 that discharges the fed document onto the document discharge tray 34. As will be described later in detail, the main frame unit 404 further includes a driving part 1502 (see FIG. 15) that drives the document feed part 408.

The back surface reading unit 410 is located downstream, in the feed direction, of a position for reading the image on one surface (front surface) of the fed document through the ADF glass 310, and upstream of the discharge roller 412 in the feed direction. The back surface reading unit 410 is, for example, a contact image sensor (CIS) and reads the image on the other surface (back surface) of the document fed from the document feed part 408. In the present embodiment, the maximum size of a document which the ADF 16 can convey is the A4 portrait size. That is, the ADF 16 is configured to be capable of conveying a document of the A4 size as the maximum document size along its longitudinal direction.

The document feed tray 32 is provided on the front side of the ADF 16 and configured such that at least a portion thereof is slidable toward the front side. Specifically, the document feed tray 32 includes a main body tray 414 having a first support surface 414a that supports a placed document, and the sub tray 416 having a second support surface 416a that supports the document with the first support surface 414a. The main body tray 414 is fixedly provided to the main frame 406 and formed such that the first support surface 414a is inclined downward from the front side toward the rear side. The sub tray 416 is configured to be slidable between a first position (the position illustrated in FIG. 1A) in which the sub tray 416 partly forms the exterior shape of the housing 402 of the ADF 16, and a second position (see FIG. 4B) in which the sub tray 416 can support a placed document with the first support surface 414a and the second support surface 416a. In the case where the sub tray 416 in the first position, the second support surface 416a is exposed at the outer surface of the housing 402. The second position is located forward of the first position.

The document feed part 408 includes a pickup roller 422 that picks up the top document among multiple documents placed on the document feed tray 32, and a separation part 426 that separates and conveys documents thus picked up individually into a conveyance path 424 (see FIG. 2). The separation part 426 includes a separation roller 430 and a separation pad 428 which cooperate with each other to separate picked documents into individual sheets.

Each individual document picked up by the pickup roller 422 and separated by the separation part 426 is fed from the front side toward the rear side and transferred into the conveyance path 424. The conveyance path 424 is formed so as to be curved in a substantially U-shape. The document transferred from the front side toward the rear side is changed to the transfer direction from the rear side toward the front side through the curved portion. At the curved portion of the conveyance path 424, a conveyance roller 432 capable of conveying the document is provided. The document conveyed by the conveyance roller 432, thus is changed to the conveyance direction from the rear side toward the front side through the conveyance path 424, then reaches a position opposed to the ADF glass 310, at which the image on the front surface of the document is read. The back surface reading unit 410 is provided downstream of this position in the conveyance path 424 in the conveyance direction of the document. In a case of reading the back surface of the document, the image on the back surface of the document is read at a position opposed to the back surface reading unit 410.

The discharge roller 412 discharges the document conveyed thereto through the conveyance path 424 onto a discharge support surface 434 and the document discharge tray 34. The direction in which the document is discharged is the direction from the rear side toward the front side, which is opposite from the direction of feed by the pickup roller 422 and the like through the conveyance path 424.

The document discharge tray 34 is provided so as to be capable of being inserted into and drawn from a space under the discharge support surface 434 formed integrally with the housing 402 of the ADF 16. The document discharge tray 34 in the inserted state can be drawn toward the front side from the rear side. The document discharge tray 34 in the drawn state can be inserted by being pushed toward the rear side from the front side. Thus, the support surface that can support a discharged document is extended in the Y direction by drawing the document discharge tray 34. A gripping portion 436 for the user to grip to insert and draw the document discharge tray 34 is formed at the front end of the document discharge tray 34 (see FIGS. 1A and 4A).

### <Document Feed Tray>

Next, the document feed tray 32 will be described in detail. In a case where the ADF 16 is not used, the document feed tray 32 is in a retracted state in which the sub tray 416 is in the first position, so that the sub tray 416 forms the exterior shape (exterior surface) of the ADF 16 (see FIG. 1A). In this first position, a back surface 416b of the sub tray 416 faces the main body tray 414 and covers the top of the main body tray 414. In a case where the ADF 16 is used, the sub tray 416 is located in the second position, in which the second support surface 416a of the sub tray 416 and the first support surface 414a of the main body tray 414 form a support surface for supporting documents, and documents are placed on this support surface.

The second support surface 416a of the sub tray 416 in the first position is exposed to the outside. Thus, the configuration is such that the second support surface 416a can form a support surface on which documents can be placed with the first support surface 414a of the main body tray 414 by simply drawing the sub tray 416 from the first position to the second position and then lifting up its tip.

The second support surface 416a of the sub tray 416 located in the first position is flush with an upper surface 402a of the housing 402 or continuous with the upper surface 402a with substantially no step therebetween (see FIG. 1A). Incidentally, the image reading apparatus 10 is designed such that the upper surface 402a and the second support surface 416a are substantially horizontal in a case where the image reading apparatus 10 is installed. This enables documents and the like to be stably placed on the upper surface of the image reading apparatus 10 formed of the upper surface 402a and the second support surface 416a.

The first and second support surfaces 414a and 416a may be continuous with each other in the Y direction or a gap may be left between the first and second support surfaces 414a and 416a in the Y direction in the state where the sub tray 416 is in the second position. Alternatively, a step may be present between the first and support surfaces 414a and 416a in the state where the sub tray 416 is in the second position. Moreover, the second support surface 416a of the sub tray 416 in the first position may be inclined with respect to a horizontal plane. Furthermore, the sub tray 416 may be configured not to be exposed to the outside in the state where the sub tray 416 is in the first position. For example, the sub tray 416 may be configured to retract under a top plate portion of the housing 402 and above the main body tray 414.

The second support surface 416a of the sub tray 416 in the second position has a larger inclination angle to a horizontal plane than that of the first support surface 414a. The second support surface 416a in the second position is inclined downward in the document feed direction, i.e., from the front side toward the rear side. The sliding movement of the sub tray 416 between the first and second positions and the mechanism for the movement will be described later.

The front surface of the sub tray 416 is exposed to the outside as a part of the front surface of the ADF 16. The gripping portion 316 for the user to grip in a case of opening and closing the ADF 16 and also in a case of sliding the sub tray 416 is formed at this front surface of the sub tray 416. The gripping portion 316 includes a notched portion 316a (see FIG. 1A) notched so as to form an opening in the lower side of a front bent portion of the sub tray 416, and a recessed portion 316b (see FIG. 4A) formed in the back surface 416b of the sub tray 416 as an upward recess.

To draw the sub tray 416, for example, the user puts fingers on the recessed portion 316b and draws the sub tray 416 in the first position toward the front side. As described above, the gripping portion 316 is also used to open and close the ADF 16. For example, to open the ADF 16, the user puts fingers on the notched portion 316a and pulls the closed ADF 16 upward. As will be described later in detail, a force of a certain strength or higher needs to be applied to the sub tray 416 in order to slide it from the first position. Thus, pulling the ADF 16 upward with the gripping portion 316 will pivot the ADF 16 to the open state and will not draw the sub tray 416.

On the front side of the ADF 16, the document discharge tray 34 is disposed under the sub tray 416. The gripping portion 436 of the document discharge tray 34 is formed at a position corresponding to the notched portion 316a formed in the sub tray 416 (see FIG. 1A). In this way, the user grips the gripping portion 436 through the space formed by the notched portion 316a. Also, in the case where the ADF 16 is open, the user can close the ADF 16 by, for example, gripping and pushing down the gripping portion 436.

### <Document Discharge Tray>

Next, the document discharge tray 34 will be described. The document discharge tray 34 includes a main body discharge tray 352 and a sub discharge tray 354. The main body discharge tray 352 is slidably supported on the housing 402 so as to be capable of being inserted and drawn. The document discharge tray 34 can be slid to be drawn from the housing 402 in the same direction as the direction in which the sub tray 416 is slid from the first position to the second position. The drawn document discharge tray 34 is located under the sub tray 416 in the second position (see FIG. 4A).

The sub discharge tray 354 is pivotally supported at the front end of the main body discharge tray 352 about a pivotal shaft parallel to the X direction. The sub discharge tray 354 can be folded so as to be housed in a housing portion 356 of the main body discharge tray 352 (see FIG. 4B). An upper surface 354a of the sub discharge tray 354 housed in the housing portion 356 is substantially flush with an upper surface 352a of the main body discharge tray 352. A back surface 354b of the sub discharge tray 354 in the spread state forms a placement surface to place discharged documents with the upper surface 352a.

The document discharge tray 34 is designed to be shorter than the document feed tray 32 in the X direction (see FIGS. 1A and 1B). In the ADF 16, the document discharge tray 34 is formed at such a position as not to overlap the operation panel 18, which is provided near the left end of the front (front surface) of the image reading apparatus 10, in the X direction (see FIG. 1B). In this way, the document discharge tray 34 in the drawn state will not overlap the operation panel 18 in a case where the user looks at the front of the image reading apparatus 10 from obliquely above.

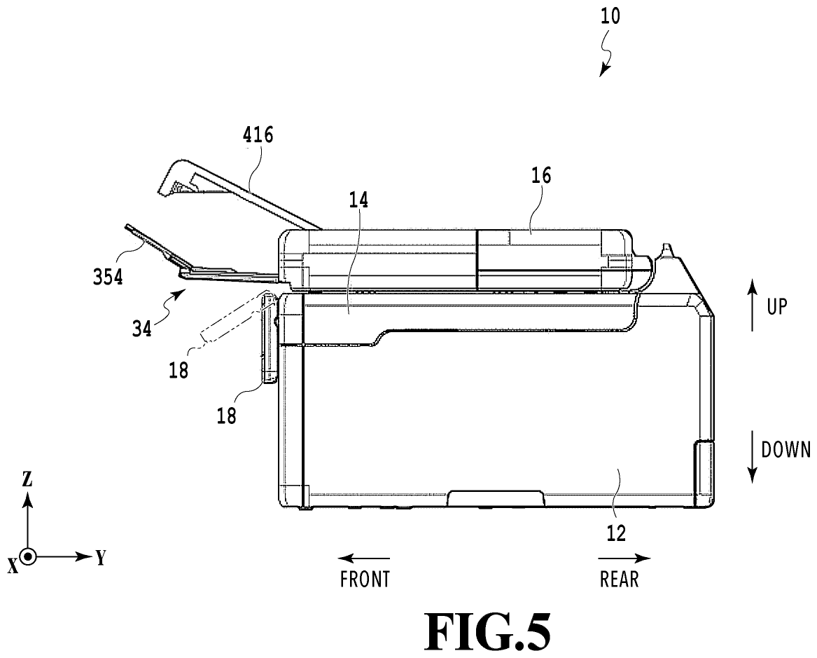

The operation panel 18 is provided so as to be pivotable within a predetermined range about a pivotal shaft parallel to the X direction. For example, the operation panel 18 is configured to be settable in a desired pivotal position within the above predetermined range (see FIG. 5). FIG. 5 is a right side view of the image reading apparatus 10. The predetermined range within which the operation panel 18 can be pivoted is, for example, such a range that the user facing the front of the image reading apparatus 10 can visually recognize what is displayed on the display part 44 and operate the physical switches 42. The operation panel 18 may be configured such that the position at which it can be fixed changes in a stepwise manner or continuously.

Assume that the document discharge tray 34 is disposed at such a position as to overlap the operation panel 18 in the X direction. Then, in a case where the document discharge tray 34 is drawn, it covers part of the operation panel 18 from above, thereby deteriorating the operability and visibility of the operation panel 18 for the user. In particular, the document discharge tray 34 is drawn from the lower side of the ADF 16 disposed at the top of the image reading apparatus 10. Accordingly, the drawn document discharge tray 34 and the operation panel 18 are close to each other in distance in the Z direction. This significantly deteriorates the operability and visibility of the operation panel 18.

In the present embodiment, the document discharge tray 34 is formed at such a position as not to overlap the operation panel 18 in the X direction to prevent the above-described deterioration in the operability and visibility of the operation panel 18 for the user. Incidentally, the document discharge tray 34 and the operation panel 18 may have such a positional relationship as to overlap each other in the X direction with the size of the image reading apparatus 10, the size of the operation panel 18, and the like taken into account. In this case, for example, the document discharge tray 34 may be disposed so as not to overlap at least the display part 44 to ensure operability and visibility on the display part 44.

In the present embodiment, the sub tray 416 of the document feed tray 32 located above the document discharge tray 34 is designed to be longer than the document discharge tray 34 in the X direction. Thus, in the case where the sub tray 416 is in the second position, the sub tray 416 covers part of the operation panel 18 from above. However, the sub tray 416 is located above the document feed tray 32 and is inclined in the second position, so that the distance to the operation panel 18 from the sub tray 416 in the Z direction is longer than the distance from the document discharge tray 34. Thus, the effect of the above design on the operability and visibility of the operation panel 18 for the user is low. Accordingly, in the present embodiment, the above-described configuration of the document discharge tray 34 and the sub tray 416 of the document feed tray 32 prevents the image reading apparatus 10 from becoming large in size while also ensuring the operability and visibility of the operation panel 18.

### (Conveyance Center of Documents at ADF)

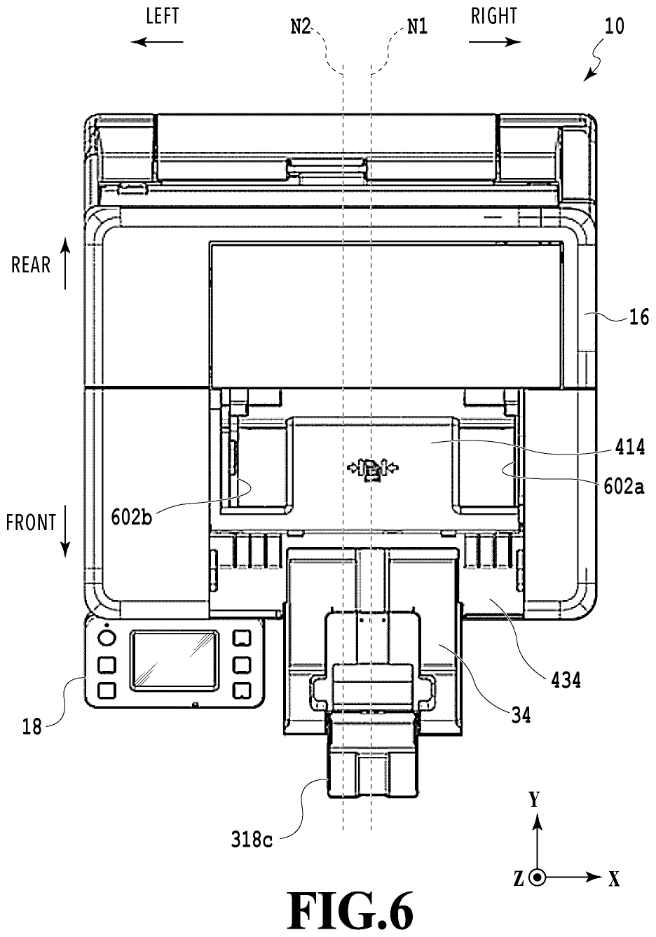

Next, the conveyance center of documents at the ADF 16 will be described. FIG. 6 is a view illustrating the conveyance center of documents at the ADF 16 in the X direction and the center position of the image reading apparatus 10 in the X direction. In FIG. 6, illustration of the sub tray 416 of the document feed tray 32 is omitted to facilitate understanding.

As illustrated in FIG. 6, a conveyance center N1 of documents at the ADF 16 in the X direction is located to the right of a center position N2 of the image reading apparatus 10. The conveyance center N1 of documents at the ADF 16 in the X direction is defined as the center position, in the X direction, of the document conveyance route from the document feed tray 32 and the document feed part 408 to the discharge roller 412 and the document discharge tray 34. The center position N2 of the image reading apparatus 10 in the X direction is defined as the center position between both ends of the exterior shape of the image reading apparatus 10 crossing (normal to) the X direction. Hereinafter, the “conveyance center N1 of documents” will be referred to simply as “conveyance center N1” as appropriate, and the “center position N2 of the image reading apparatus 10” will be referred to simply as “center position N2” as appropriate.

In the present embodiment, on the main body tray 414 of the document feed tray 32, a pair of restriction guides 602 are provided which restrict both of the ends of a placed document in the width direction (X direction). The pair of restriction guides 602 are such that their restriction surfaces 602a and 602b facing each other are movable in the X direction toward or away from each other according to the size of the document. Thus, the restriction surfaces 602a and 602b set the center position of the placed document in the X direction. Accordingly, the center position between the restriction surfaces 602a and 602b of the restriction guides 602 in the X direction, in other words, the center position, in the X direction, of a document restricted by the restriction guides 602, can be considered the conveyance center N1 of the document. Note that, in the present embodiment, the center position of the document discharge tray 34 in the X direction substantially coincides with the conveyance center N1 of the document.

The pair of restriction guides 602 provided on the main body tray 414 may be such that the restriction surface on one of them is fixed and the restriction surface on the other is movable according to the size of the placed document. In this case, the position of the conveyance center N1 of a document in the X direction shifts according to the size of the document. Thus, in the case of such a configuration, the restriction guides are formed such that documents of all compatible sizes restricted by the restriction guides have their conveyance centers N1 located to the right of the center position N2.

The conveyance center N1 of documents is located to the right of the center position N2 but is not limited to this position, and may be located to the left of the center position N2. In the present embodiment, the conveyance center N1 is offset to the right, which is the side in the X direction where the operation panel 18 is not located, in consideration of the visibility and operability of the operation panel during conveyance of a document. In sum, in the present embodiment, the conveyance center N1 of documents is set to be offset from the center position N2 of the image reading apparatus 10 in the X direction toward the opposite side from the operation panel 18.

In the present embodiment, the operation panel 18 is provided near the left end of the front of the image reading apparatus 10 but is not limited to this position. The operation panel 18 may overlap the center position N2 in the X direction. That is, the amount of offset between the center of the operation panel 18 and the center position N2 in the X direction may be small. The operation panel 18 is preferably located to the left or right of the center position N2 of the image reading apparatus 10. For example, the entire operation panel 18 may be disposed to be off the center position N2 in the X direction. In this case, based on the position where the operation panel 18 is disposed, the positions to dispose other constituent elements such as the document discharge tray 34 are determined with the visibility and operability of the operation panel 18 taken into account. While the amount of offset of the conveyance center N1 of documents from the center position N2 of the image reading apparatus 10 may be small, the above-mentioned relationship between the operation panel 18, and the document discharge tray 34 and the sub tray 416 is preferably satisfied.

The offset of the conveyance center N1 from the center position N2 in the X direction increases the size of the region in the ADF 16 where documents do not pass that is located on the opposite side in the X direction from the side toward which the conveyance center N1 is offset from the center position N2. This enables many of the constituent elements of the ADF 16 to be housed in the region where documents do not pass.

### (Configuration for Making Sub Tray 416 Slidable)

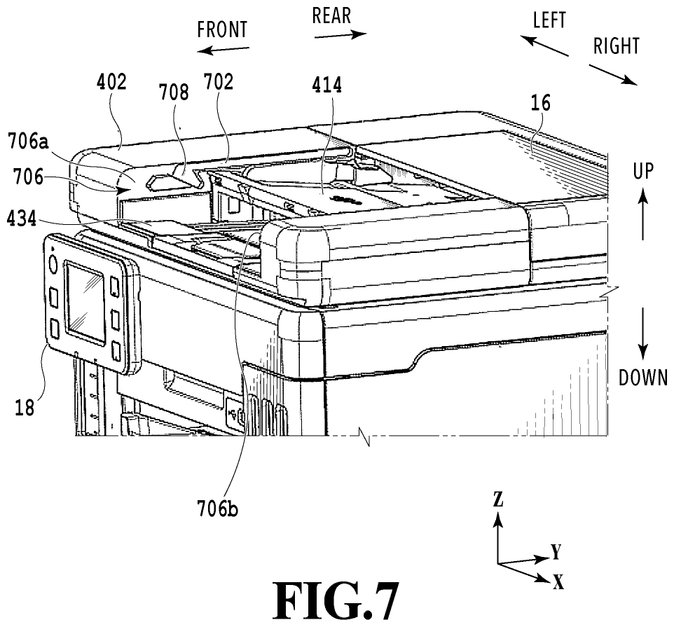

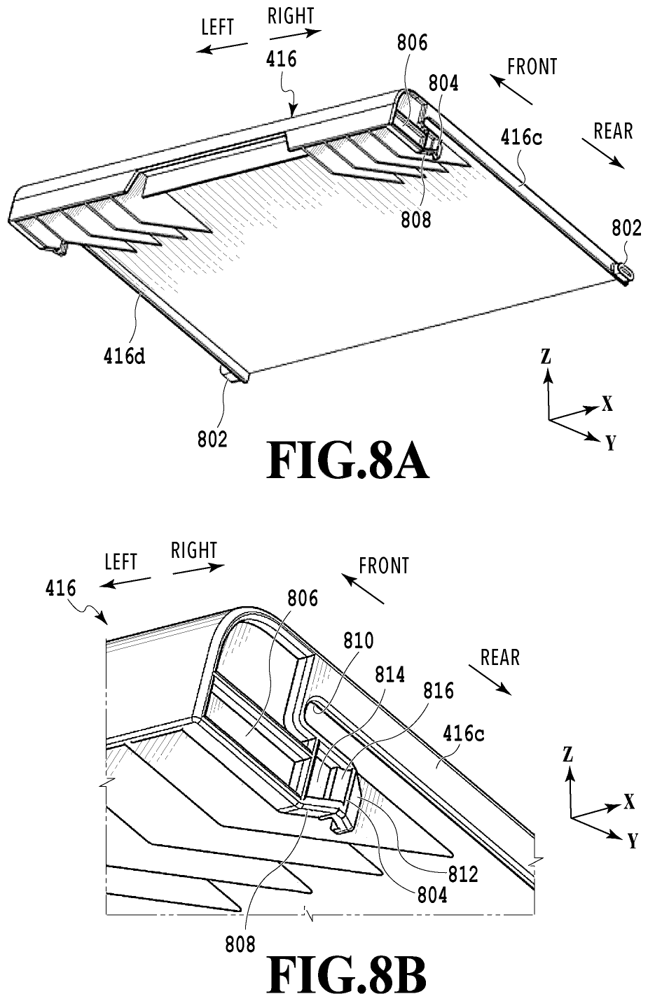

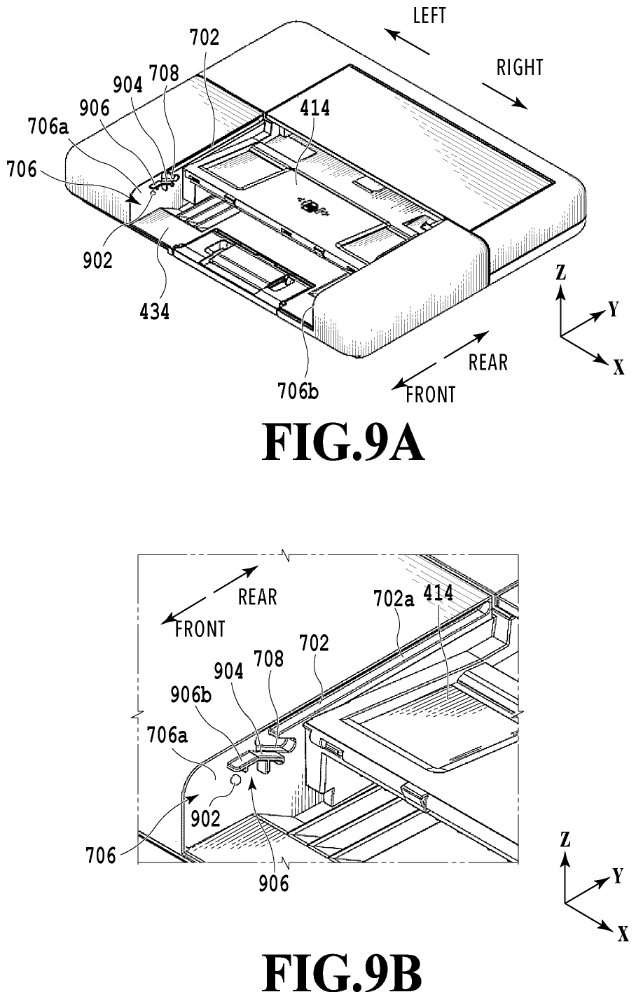

Next, a configuration for making the sub tray 416 slidable will be described. FIG. 7 is a perspective view of the image reading apparatus 10. The sub tray 416 is omitted in the illustration of FIG. 7 to facilitate understanding. FIG. 8A is a perspective view of the sub tray 416 as seen from a lower side. FIG. 8B is an enlarged view of a pressing portion 804 of the sub tray 416 and its periphery. FIG. 9A is a perspective view of the ADF 16. FIG. 9B is an enlarged view of a rail portion 702 and its periphery. Note that the configuration for making the sub tray 416 slidable is formed at the left and right side surfaces of the sub tray 416 and the left and right side walls of an opening portion 706 in which documents are fed and discharged.

The configuration for making the sub tray 416 slidable includes the rail portions 702 (see FIG. 7) extending in the direction in which the sub tray 416 is slid, and protruding portions 802 (see FIG. 8A) provided on the sub tray 416 and slidably supported on the rail portions 702. Also, in order to enable the sub tray 416 to maintain the inclined posture in the second position, the configuration for making the sub tray 416 slidable includes holding portions 708 that holds the sub tray 416 in the inclined state.

The rail portions 702 are provided in the housing 402 of the ADF 16 and formed so as to be engageable with the protruding portions 802. Specifically, the rail portions 702 are configured to be capable of guiding the sub tray 416 with the protruding portions 802 engaged with the rail portions 702 in the extending direction of the rail portions 702. Though the illustration is hidden by the housing 402, the rail portions 702 are provided respectively at opposed positions in a left side wall 706a and a right side wall 706b of the opening portion 706, in which the main body tray 414 is formed and documents are fed and discharged.

The protruding portions 802 are formed so as to protrude in the X direction from the rear ends of a right side surface 416c and a left side surface 416d of the sub tray 416. The protruding portion 802 provided on the right side surface 416c is formed to protrude rightward so as to be engageable with and slidable on the rail portion 702 provided in the right side wall 706b. The protruding portion 802 provided on the left side surface 416d is formed to protrude leftward so as to be engageable with and slidable on the rail portion 702 provided in the left side wall 706b.

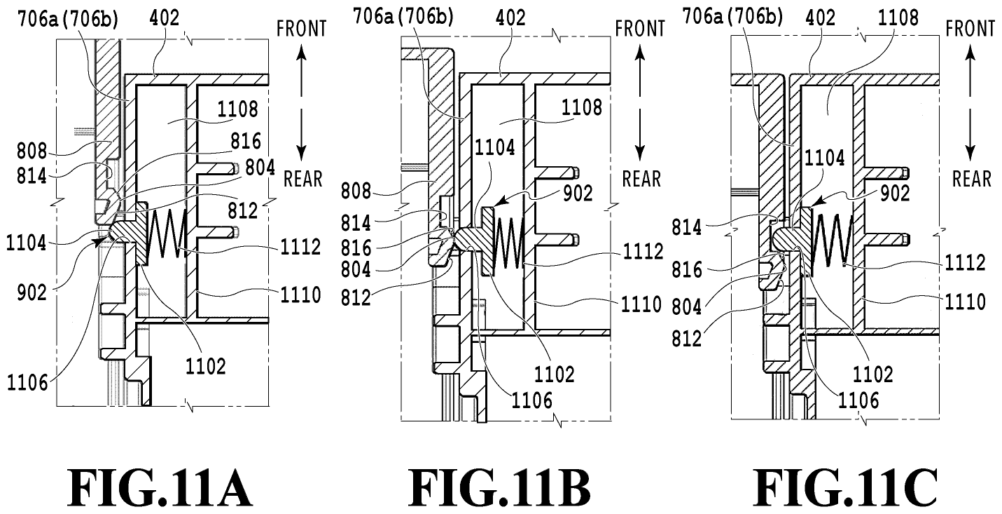

The configuration for making the sub tray 416 slidable also includes retaining portions 902 which are provided to the housing 402 and retain the sub tray 416 in the first position (see FIGS. 9A and 9B). The configuration for making the sub tray 416 slidable also includes pressing portions 804 which are provided to the sub tray 416 and press the retaining portions 902 immediately before the sub tray 416 gets retained in the first position by the retaining portions 902 (see FIGS. 8A and 8B). In the present embodiment, the retaining portions 902 are provided to the housing 402, and the pressing portions 804 are provided to the sub tray 416, but the configuration is not limited to this one. The retaining portions 902 may be provided to the sub tray 416, and the pressing portions 804 may be provided to the housing 402. In the movement of the sub tray 416 between the first and second positions, the pressing portions 804 press the retaining portions 902 at a predetermined position (the position illustrated in FIG. 11B) situated on the second position side relative to the first position but close to the first position, and do not press the retaining portions 902 on the second position side from the predetermined position.

### <Constituent Elements Provided to Sub Tray 416>

Now, the constituent elements provided to the sub tray 416 as the configuration for making the sub tray 416 slidable will be described in detail. Note that the configuration for making the sub tray 416 slidable is the same on the left and right sides of the sub tray 416 and the opening portion 706 except that the left-right direction is different. The sub tray 416 includes the protruding portions 802 and extending portions 808 as the configuration for making the sub tray 416 slidable. As each extending portion 808, a pressing portion 804, inclined surfaces 812 and 816, and a recessed portion 814 are formed. Each member will be described in detail below.

### =Protruding Portions 802=

The protruding portions 802 provided on the right and left side surfaces 416c and 416d of the sub tray 416 each have a substantially quadrangular prism shape extending in the Y direction with chamfered or circular arc corners. The protruding portions 802 may have, for example, a substantially elliptical column shape with the opposed front and rear surfaces having a circular arc shape and the opposed upper and lower surfaces having a linear shape in parallel to each other (see FIG. 8A). The protruding portions 802 may, for example, have a cylindrical shape or be rotatable rollers. In this case, multiple protruding portions 802 are provided on each side surface (e.g., a total of two protruding portions 802 are provided on each side surface near the front and rear ends).

### =Extending Portions 808=

At the front ends of the side surfaces 416c and 416d of the sub tray 416, a bent portion 806 is provided which is bent downward in conformity with the bent shape of the front side of the sub tray 416. At the rear end of the bent portion 806, the corresponding extending portion 808 is formed so as to protrude rearward. Between the side surfaces 416c and 416d and the respective extending portions 808, a recessed portion 810 is formed so as to extend beyond the rear end of the extending portion 808 toward the front side (see FIG. 8B). Thus, a gap is provided between the side surfaces 416c and 416d and the respective extending portions 808 in the Z direction.

### =Pressing Portions 804=

The pressing portions 804 are provided near the rear ends of the respective extending portions 808. The pressing portion 804 provided to the extending portion 808 on the right side surface 416c side protrudes rightward (see FIG. 8B). The pressing portion 804 provided to the extending portion 808 on the left side surface 416d side protrudes leftward. Each extending portion 808 has the corresponding inclined surface 812 formed rearward of the pressing portion 804, and has the corresponding recessed portion 814 formed forward of the pressing portion 804.

### =Inclined Surfaces 812 and 816 and Recessed Portions 814=

The inclined surface 812 provided to the extending portion 808 on the right side surface 416c side is inclined leftward toward the rear side (see FIG. 8B). The inclined surface 812 provided to the extending portion 808 on the left side surface 416d side is inclined rightward toward the rear side. The recessed portions 814 have a recessed shape capable of housing the retaining portions 902. The inclined surfaces 816 are formed between the recessed portions 814 and the pressing portions 804. The inclined surface 816 provided to the extending portion 808 on the right side surface 416c side is inclined leftward toward the front side (see FIG. 8B). The inclined surface 816 provided to the extending portion 808 on the left side surface 416d side is inclined rightward toward the front side.

### <Constituent Elements Provided to Housing 402>

Next, the constituent elements provided to the housing 402 as the configuration for making the sub tray 416 slidable will be described. The housing 402 includes the rail portions 702, the holding portions 708, inclined support portions 904, auxiliary support portions 906, and the retaining portions 902 as the configuration for making the sub tray 416 slidable (see FIGS. 9A and 9B). Each member will be described in detail below.

### =Rail Portions 702=

The rail portions 702 are formed in the left and right side walls 706a and 706b of the opening portion 706 at such a height position that the second support surface 416a of the sub tray 416 and the upper surface 402a of the housing 402 are substantially flush with each other in a case where the sub tray 416 is in the first position with the protruding portions 802 engaged with the respective rail portions 702. The left and right side walls 706a and 706b are formed to be substantially perpendicular to the discharge support surface 434. The rail portions 702 have a recessed shape extending in the Y direction, and are formed as recesses in the wall surfaces of the respective side walls (see FIG. 9B). Each rail portion 702 is formed such that its length in the Z direction (height direction) is slightly greater than the length of the corresponding protruding portion 802 in the Z direction. Thus, in a case where the protruding portions 802 are engaged with the respective rail portions 702, the sub tray 416 can be slid in the Y direction on the protruding portions 802.

The rail portions 702 and the holding portions 708 are integrally formed with the side walls 706a and 706b (the holding portions 708 will be described later) but are not limited to this configuration. The rail portions 702 and the holding portions 708 may be separate members fixed to the side walls 706a and 706b. Also, the rail portions 702 have a recessed groove shape extending in the Y direction but are not limited to this shape. The rail portions 702 may be formed to protrude from the side walls 706a and 706b so as to sandwich the protruding portions 802 in the transverse direction of the protruding portions 802.

### =Holding Portions 708=

The holding portions 708 are formed in the left and right side walls 706a and 706b at the front ends of the rail portions 702. Each of the holding portions 708 has a recessed shape formed as a recess continuous with the rail portion 702 in the wall surface of the corresponding side wall. The holding portions 708 are formed so as to be inclined downward toward the rear side from the front side where the holding portions 708 communicate with the rail portions 702. The holding portions 708 are provided forward of the main body tray 414 (see FIGS. 9A and 9B).

In this way, the protruding portions 802 can be inserted into the holding portions 708 by sliding the sub tray 416 toward the front side to move the protruding portions 802 to the front ends of the rail portions 702 and lifting up the front side of the sub tray 416. Then, by pushing down the sub tray 416, the protruding portions 802 move according to the inclinations of the holding portions 708 to the rear ends of the holding portions 708. The protruding portions 802 have a shape elongated along the extending direction of the side surfaces of the sub tray 416. Thus, the surfaces of the protruding portions 802 extending in this extending direction (the surfaces opposed in the Z direction in FIG. 8A) abut on the inner wall surfaces of the holding portions 708, so that the sub tray 416 is held in a posture corresponding to the inclination of the holding portions 708.

### =Inclined Support Portions 904=

The inclined support portions 904 are provided below the holding portions 708 on the side walls 706a and 706b so as to protrude from the respective wall surfaces (see FIG. 9B). The inclined support portions 904 are inclined according to the inclinations of the holding portions 708, and supports the lower portions of the side surfaces 416c and 416d of the sub tray 416 in the case where the protruding portions 802 are held in the holding portions 708. This enables the sub tray 416 to stably maintain the inclined posture in the second position. Incidentally, the inclined support portions 904 may be omitted as long as the protruding portions 802 and the holding portions 708 can stably maintain the sub tray 416 in the inclined posture in the second position.

### =Auxiliary Support Portions 906=

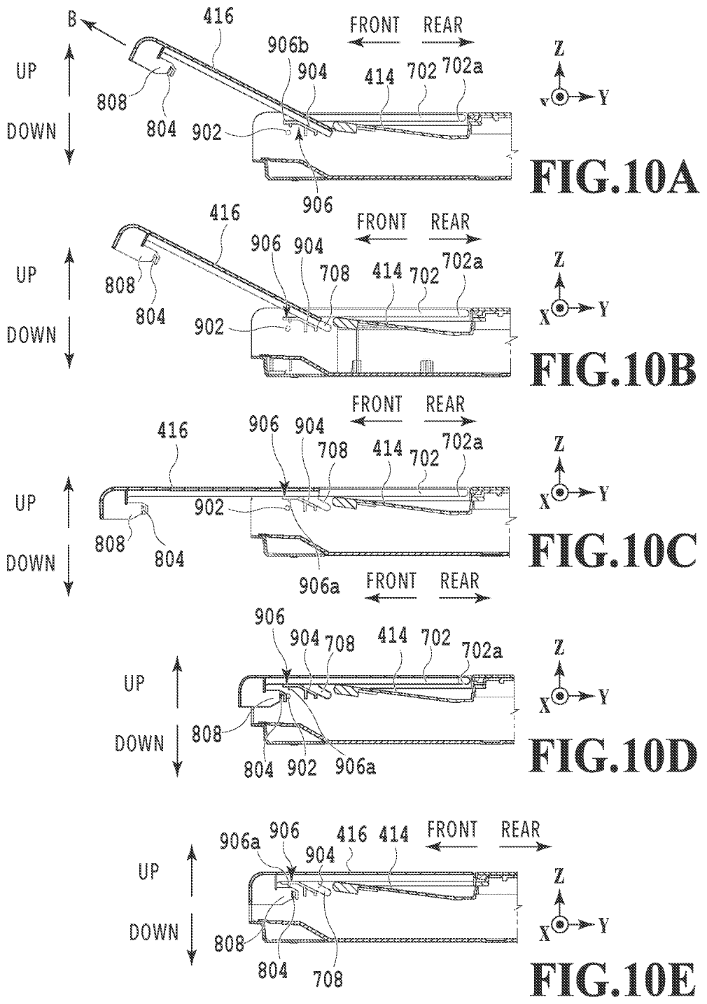

The auxiliary support portions 906 are provided on the front sides of the inclined support portions 904 on the side walls 706a and 706b (see FIG. 9B). The auxiliary support portions 906 support the side surfaces of the sub tray 416 from below at positions forward of the rail portions 702 so as to be capable of assisting the sliding movement of the sub tray 416. The auxiliary support portions 906 are formed so as to protrude from the wall surfaces of the side walls 706a and 706b. The rear ends of the auxiliary support portions 906 are connected to the front ends of the inclined support portions 904. The joints between the auxiliary support portions 906 and the inclined support portions 904 are formed to be smooth. The height positions of upper surfaces 906b of the auxiliary support portions 906 (the positions in the Z direction) and the height positions of lower surfaces 702a of the rail portions 702 are substantially the same (see FIGS. 8B and 10A). This prevents the auxiliary support portions 906 from interfering with the sub tray 416 when the sub tray 416 is caused to incline by the protruding portions 802 and the holding portions 708.

### =Retaining Portions 902=

The retaining portions 902 are provided under the auxiliary support portions 906 on the side walls 706a and 706b. The retaining portions 902 are provided so as to project from the wall surfaces of the side walls 706a and 706b with urging springs 1112 (see FIG. 11A) provided in the housing 402. Since the retaining portions 902 project from the wall surfaces with the urging forces of the urging springs 1112, the retaining portions 902 move in the opposite directions from their projecting directions against the urging forces of the urging springs 1112 in response to application of external forces to the retaining portions 902.

The retaining portions 902 are provided at such positions as to be engageable with the recessed portions 814 of the sub tray 416 in the first position. As will be described later in detail, the pressing portions 804 provided to the extending portions 808 push the retaining portions 902 when the sub tray 416 is pushed into the first position. This gives a clicky feel (feedback) to the user. Then, the retaining portions 902 enter and engage the recessed portions 814 of the extending portions 808, so that the sub tray 416 becomes retained in the first position.

### (Sliding Movement of Sub Tray 416)

Next, a moving operation of the sub tray 416 between the first and second positions including the sliding movement of the sub tray 416 will be described. FIGS. 10A to 10E are views explaining the moving operation of the sub tray 416. FIG. 10A is a view illustrating a state where the sub tray 416 is in the second position. FIG. 10B is a view illustrating a state where the sub tray 416 is pulled up from the second position. FIG. 10C is a view illustrating a state where the sub tray 416 is laid to a horizontal position. FIG. 10D is a view illustrating a state where the sub tray 416 is slid to bring the inclined surfaces 812 into abutment with the retaining portions 902. FIG. 10E is a view illustrating a state where the sub tray 416 is in the first position.

=Movement from Second Position to First Position=

In the second position, the protruding portions 802 provided on the sub tray 416 are held in the holding portions 708 provided in the housing 402, so that lower portions of the side surfaces 416c and 416d of the sub tray 416 are supported on the inclined support portions 904 (see FIG. 10A). To move the sub tray 416 from the second position to the first position, first, the sub tray 416 in the second position is pulled obliquely upward toward the front side (see the arrow B in FIG. 10A). As a result, the protruding portions 802 are pulled out of the holding portions 708 (see FIG. 10B) so that the front side of the sub tray 416 can be pushed down. Note that the views illustrated in FIGS. 10A to 10E are cross-sectional views taken along a substantially center position of the opening portion 706 in the X direction. Thus, in the views illustrated in FIGS. 10A to 10E, the leader line for the pressing portion 804 is depicted from its back surface.

Next, the front side of the sub tray 416 is pushed down to lay the sub tray 416 to a substantially horizontal position in which the protruding portions 802 can be inserted into the rail portions 702 (see FIG. 10C). At this time, lower portions of the side surfaces 416c and 416d are supported on the auxiliary support portions 906. Thereafter, the sub tray 416 is pushed toward the rear side, so that the sub tray 416 is guided by the rail portions 702 on the protruding portions 802 while the lower portions of the side surfaces 416c and 416d are supported on the auxiliary support portions 906. As a result, the sub tray 416 slides toward the first position while maintaining the horizontal posture. As the sub tray 416 reaches the vicinity of the first position, the inclined surfaces 812 of the extending portions 808 come into abutment with the retaining portions 902 (see FIG. 10D).

As the sub tray 416 is pushed farther toward the rear side from the position at which the inclined surfaces 812 abut on the retaining portions 902, the pressing portions 804 of the extending portions 808 come into abutment with the retaining portions 902. At this time, a clicky feel is given to the user. As the sub tray 416 is pushed farther toward the rear side, the retaining portions 902 engage the recessed portions 814 of the extending portions 808, so that the sub tray 416 becomes retained in the first position (see FIG. 10E). The mechanism of how the clicky feel is given to the user will be described later.

In the state where the sub tray 416 is in the first position, the auxiliary support portions 906 are situated in the recessed portions 810. On the lower surface of each of the auxiliary support portions 906, there is formed a protrusion 906a protruding downward. In the state where the auxiliary support portions 906 are situated in the recessed portions 810, the protrusions 906a are in abutment with upper portions of the extending portions 808 or in the vicinity of the upper portions with a slight gap therebetween (see FIG. 10E). With the protrusions 906a in abutment with or in the vicinity of the extending portions 808 in the state where the sub tray 416 is in the first position as described above, the sub tray 416 cannot be easily moved from the first position when the sub tray 416 is lifted up. This prevents only the sub tray 416 from being drawn when the user grips the gripping portion 316 and lifts up the sub tray 416. Accordingly, the ADF 16 can be more reliably pivoted into the open state.

=Movement from First Position to Second Position=

To move the sub tray 416 from the first position to the second position, the opposite operation of the above moving operation from the second position to the first position is performed. Specifically, by gripping the gripping portion 316 and pulling the sub tray 416 in the first position toward the front side, the pressing portions 804 move over the retaining portions 902, and the inclined surfaces 812 come into abutment with the retaining portions 902 (see FIG. 10D). At this time, a clicky feel is given to the user.

Next, the sub tray 416 is pulled farther by sliding it substantially horizontally to pull the protruding portions 802 out of the rail portions 702 so that the front end of the sub tray 416 can be lifted up (see FIG. 10C). Thereafter, the front end of the sub tray 416 is lifted up to tilt the sub tray 416 (see FIG. 10B) such that the protruding portions 802 can be inserted into the holding portions 708. Then, the sub tray 416 is pushed obliquely downward toward the rear side to insert the protruding portions 802 into the holding portions 708, so that the sub tray 416 is set in the second position in an inclined posture corresponding to the inclination of the holding portions 708 (see FIG. 10A).

### (Giving Clicky Feel to User)

Next, the clicky feel, i.e., feedback, given to the user when the sub tray 416 is set in the first position and moved from the first position will be described. FIGS. 11A to 11C are views illustrating the states of a pressing portion 804 and the corresponding retaining portion 902 in a case where the sub tray 416 is in the first position and in cases where the sub tray 416 is near the first position. FIG. 11A is a view illustrating the positional relationship between the pressing portion 804 and the retaining portion 902 in the case where the sub tray 416 is located near the first position. FIG. 11B is a view illustrating the positional relationship between the pressing portion 804 and the retaining portion 902 in the case where the sub tray 416 is located closer to the first position than its position in FIG. 11A. FIG. 11C is a view illustrating the positional relationship between the pressing portion 804 and the retaining portion 902 in the case where the sub tray 416 is located in the first position. Incidentally, FIG. 11A corresponds to FIG. 10D, and FIG. 10C corresponds to FIG. 10E.

=Movement from Second Position to First Position=

In the case of moving the sub tray 416 from the second position to the first position, the inclined surfaces 812 of the extending portions 808 come into abutment with the retaining portions 902 immediately before the sub tray 416 reaches the first position (see FIGS. 11A and 10D). At this time, the tips of the retaining portions 902 come into abutment with the rear ends of the inclined surfaces 812 (see FIG. 11A).

Here, each of the retaining portions 902 includes a base portion 1102 and a protruding portion 1104 protruding from one surface of the base portion 1102. The tip of the protruding portion 1104 has a dome shape, i.e., a semispherical shape. The retaining portions 902 are disposed such that their protruding portions 1104 are inserted through through-holes 1106 formed in the side walls 706a and 706b of the housing 402 and project from the wall surfaces. In this state, the base portions 1102 are located inside respective internal spaces 1108 provided in the housing 402, and are urged in the directions in which the protruding portions 1104 project from the wall surfaces by the urging springs 1112 provided on inner walls 1110 in these internal spaces 1108.

The retaining portion 902 provided on the right side wall 706b is urged leftward by the corresponding urging spring 1112. That is, the projecting direction of the retaining portion 902 in this case is the direction from the right toward the left. The retaining portion 902 provided on the left side wall 706a is urged rightward by the corresponding urging spring 112. That is, the projecting direction of the retaining portion 902 in this case is the direction from the left toward the right. In the above case, the base portions 1102 abut on the back surfaces of the respective side walls, so that the amount of projection of the protruding portions 1104 is maintained constant. In the case where the retaining portions 902 are pushed in the directions opposite to their projecting directions, the retaining portions 902 move in these directions opposite to their projecting directions against the urging forces of the urging springs 1112. In FIG. 11A, the base portion 1102 is in abutment with the side wall.

As the sub tray 416 is pushed in toward the rear side from the state of FIG. 11A, the protruding portions 1104 of the retaining portions 902 come into abutment with the inclined surfaces 812 and get pushed in the directions opposite to their projecting directions according to the inclination of the inclined surfaces 812. The retaining portions 902 then come into abutment with the pressing portions 804 (see FIG. 11B). In this operation, as the sub tray 416 is pushed in toward the rear side, the urging springs 1112 for the retaining portions 902 are pushed in the directions opposite to the projecting directions by the inclined surfaces 812, so that the resistance exerted on the sub tray 416 increases until the pressing portions 804 start pushing the retaining portions 902. Thus, the resistance exerted on the sub tray 416 gradually increases as the sub tray 416 is moved from the position in FIG. 11A to the position in FIG. 11B. The change in resistance gives a clicky feel to the user.

As the sub tray 416 is pushed in farther toward the rear side from the state of FIG. 11B, the protruding portions 1104 of the retaining portions 902 move over the pressing portions 804 and gradually shift in the projecting directions along the inclined surfaces 816 with the urging forces of the urging springs 1112. Then, as the sub tray 416 is pushed in farther toward the rear side, the protruding portions 1104 of the retaining portions 902 enter the recessed portions 814, so that the retaining portions 902 engage the recessed portions 814 (see FIG. 11C). As a result, the sub tray 416 gets retained in the first position by the retaining portions 902. The retaining portions 902 project longer in their projecting directions in the state where the sub tray 416 is in the first position than in the state where the sub tray 416 is in the above predetermined position (the position in FIG. 11B).

=Movement from First Position to Second Position=

On the other hand, in the case of moving the sub tray 416 from the first position to the second position, the sub tray 416 in the second position is retained by the retaining portions 902 engaged with the recessed portions 814 (see FIGS. 11C and 10E). The sub tray 416 is drawn toward the front side from the state of FIG. 11C. As a result, the inclined surfaces 816 located on the rear sides of the recessed portions 814 come into abutment with the protruding portions 1104 of the retaining portions 902, and the retaining portions 902 move in the directions opposite to their projecting directions against the urging forces of the urging springs 1112 according to the inclinations of the inclined surfaces 816. Then, as the sub tray 416 is drawn farther toward the front side, the retaining portions 902 come into abutment with the pressing portions 804 (see FIG. 11B).

In this operation, as the sub tray 416 is drawn toward the front side, the urging springs 1112 for the retaining portions 902 are pushed in the directions opposite to the projecting directions by the inclined surfaces 816, so that the resistance exerted on the sub tray 416 increases until the pressing portions 804 start pushing the retaining portions 902. Thus, the resistance exerted on the sub tray 416 gradually increases as the sub tray 416 is moved from the position in FIG. 11C to the position in FIG. 11B. The change in resistance gives a clicky feel to the user. Thereafter, as the sub tray 416 is drawn farther toward the front side, the retaining portions 902 move over the pressing portions 804 and project in the projecting directions according to the inclinations of the inclined surfaces 812 (see FIG. 11A).

By giving a clicky feel to the user in the case of moving the sub tray 416 between the first and second positions, the user can easily determine that the sub tray 416 has been moved from or to the first position. In the present embodiment, the retaining portions 902 engage the recessed portions 814 in the state where the sub tray 416 is in the first position. This configuration prevents the sub tray 416 from being unintentionally drawn from the first position. For example, the above configuration prevents the sub tray 416 from being unintentionally drawn in a case where the user grips the gripping portion 316 and lifts up the ADF 16. Thus, although the gripping portion for performing an operation of drawing the sub tray 416 also serves as a gripping portion for performing an operation of opening the ADF 16, the user can easily perform each of these operations as desired. This improves the operability for the user.

### (Configuration of Platen 302)

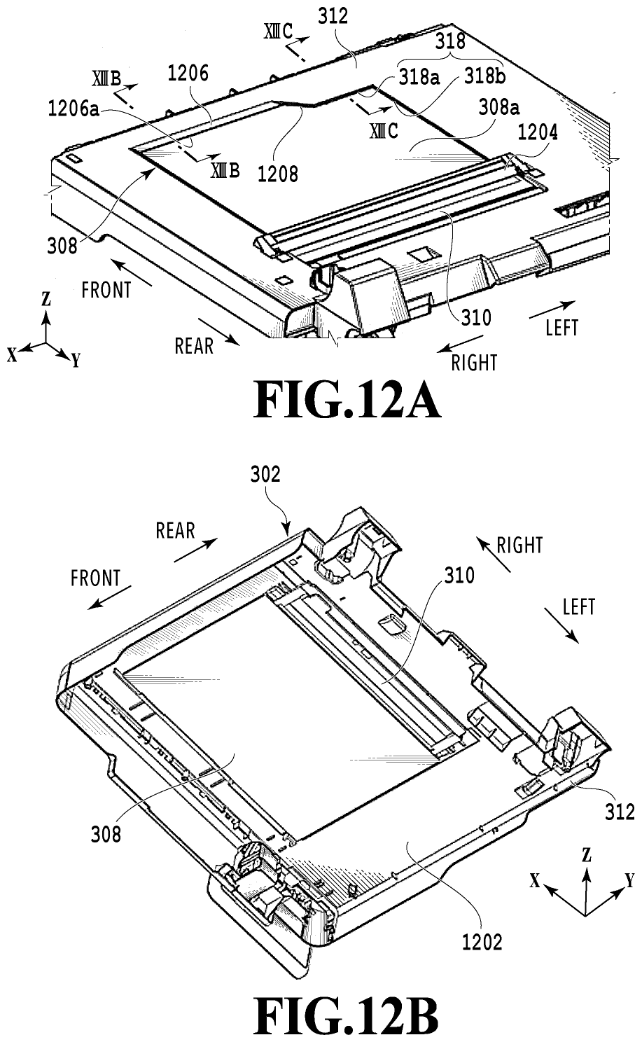

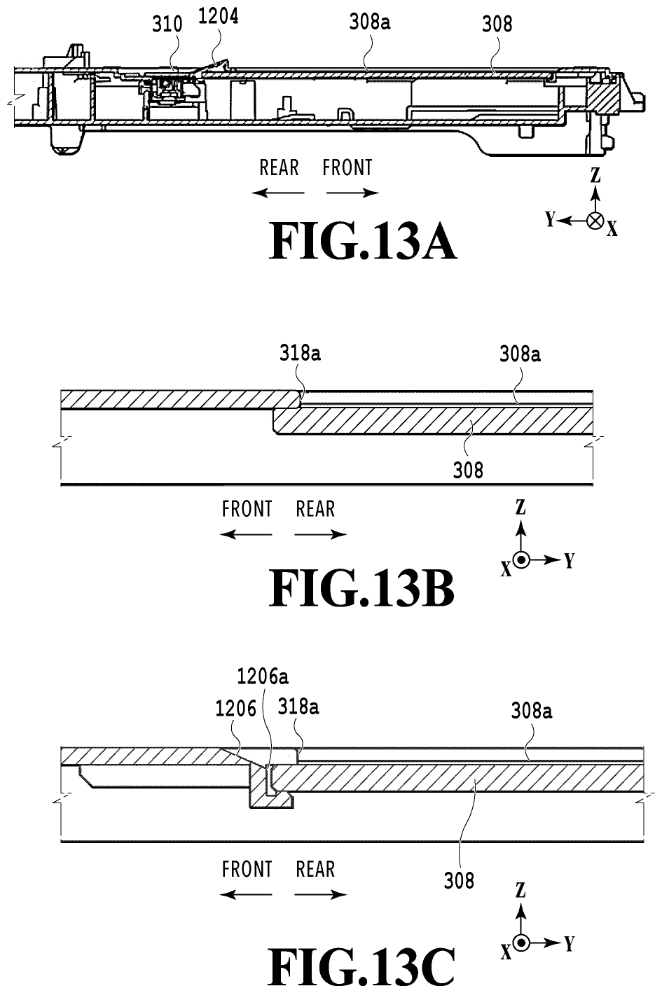

Next, a configuration of the platen 302 will be described in detail. FIGS. 12A and 12B are perspective views of the platen. FIG. 12A is a view from above. FIG. 12B is a view from below. FIGS. 13A to 13C are views explaining constituent elements of the platen. FIG. 13A is a cross-sectional view taken along a substantially center position of the image reading part 14 in the X direction. FIG. 13B is a cross-sectional view taken along the XIIIB-XIIIB line in FIG. 12A. FIG. 13C is a cross-sectional view taken along the XIIIC-XIIIC line in FIG. 12A.

The platen 302 is disposed so as to cover the reading unit 306, the constituent elements that drive the reading unit 306, and so on disposed in the housing 320 of the image reading part 14 from above. As described above, in the image reading part 14, the driving motor 326, the speed reducer 338, and the driving pulley 330 for driving the reading unit 306 are disposed together in the space to the left of the movement region Sm for the reading unit 306 (see FIG. 3B). The back side of the platen 302 includes a covering portion 1202 that covers the space in which the driving motor 326, the speed reducer 338, and the driving pulley 330 are disposed from above (see FIG. 12B). The platen glass 308 and the ADF glass 310 are located to the right of this covering portion 1202 at positions corresponding to the movement region Sm for the reading unit 306.

The first abutment portion 318a, which is provided at the boundary between the platen glass 308 and the frame member 312 and extends in the X direction, is provided at the front edge of the platen glass 308 (see FIG. 12A). A document placed on the document placement surface 308a can be positioned in the Y direction (front-rear direction) by bringing the front edge of the document into abutment with the first abutment portion 318a. The second abutment portion 318b, which is provided at the boundary between the platen glass 308 and the frame member 312 and extends in the Y direction, is provided at the left edge of the platen glass 308. A document placed on the document placement surface 308a can be positioned in the X direction (left-right direction) by bringing the left edge of the document into abutment with the second abutment portion 318b. The second abutment portion 318b may be provided at the right edge of the platen glass 308. In this case, the right edge of the document is brought into abutment with the second abutment portion 318b.

On the rear side of the platen glass 308 and the front side of the ADF glass 310, there is provided a document restriction portion 1204 that restricts a rearward movement of a document placed on the document placement surface 308a of the platen glass 308. The document restriction portion 1204 extends in the X direction (see FIG. 12A) and is formed so as to protrude upward beyond the document placement surface 308a (see FIG. 13A). Thus, a document placed on the document placement surface 308a is restricted from moving rearward beyond the document restriction portion 1204.

In the present embodiment, the maximum size of a document which can be placed on the document placement surface 308a to read the image thereon is A5. For this reason, the size of the platen glass 308 (document placement surface 308a) in the Y direction is designed based on this maximum size. In the present embodiment, the ADF 16 is used in a case of reading a document of a size larger than A5, such as A4. Thus, in the present embodiment, the fixed reading mode is intended for A5 and smaller documents and is suitable for reading documents of sizes that are difficult to convey with the ADF 16, e.g., documents of the size of a card, such as a business card and a driver's license.

Incidentally, the user may, for example, open the ADF 16 of the image reading apparatus 10 and place a document on the document placement surface 308a of the platen glass 308 from the front side or take a document off the document placement surface 308a. At the front edge of the platen glass 308, the first abutment portion 318a is located, with which an edge of a document placed on the document placement surface 308a is brought into abutment in order to position the document. Assume that the first abutment portion 318a is formed over the entire front edge of the platen glass 308, and the user tries to take a document off the document placement surface 308a. In this case, the document may touch the first abutment portion, which will make it difficult to take the document off.

For this reason, in the present embodiment, the first abutment portion 318a is formed as a region of the front edge of the platen glass 308 extending in the X direction, and the other region is formed as an inclined surface 1206 inclined upward toward the front side from the rear side (see FIG. 12A). Specifically, the inclined surface 1206 is inclined upward toward the front side from the platen glass 308. Thus, at the front edge of the platen glass 308, the inclined surface 1206 is formed to the right of the first abutment portion 318a. The inclined surface 1206 is located forward of the first abutment portion 318a.

The first abutment portion 318a is a wall rising perpendicularly to the document placement surface 308a of the platen glass 308, and the front edge of a document placed on the document placement surface 308a can abut on the first abutment portion 318a (see FIG. 13B). Note that, though not illustrated, the second abutment portion 318b is also a wall rising substantially perpendicularly to the document placement surface 308a of the platen glass 308, like the first abutment portion 318a. In contrast, the inclined surface 1206 is inclined upward toward the front side from the rear side (see FIG. 13C). A rear edge 1206a of the inclined surface 1206 located at the boundary with the platen glass 308 is situated lower than the document placement surface 308a by a certain distance. In other words, the document placement surface 308a is situated higher than the rear edge 1206a of the inclined surface 1206.

This makes it possible to smoothly slide a document over the inclined surface 1206 from the document placement surface 308a. If the rear edge 1206a is situated higher than the document placement surface 308a, a step higher than the document placement surface 308a is formed on the downstream side in the direction which a document is slid. This leads to a possibility that the document which is moved hits the step. Even if the rear edge 1206a is at the same height as the document placement surface 308a, the rear edge 1206a may still be situated slightly higher than the document placement surface 308a due to a manufacturing error or the like. In the present embodiment, the rear edge 1206a is situated lower than the document placement surface 308a as described above so that a document can be smoothly moved to the inclined surface 1206 from the document placement surface 308a.

In the present embodiment, at the front edge of the platen glass 308, the inclined surface 1206 is formed longer in the X direction than the first abutment portion 318a. The first abutment portion 318a is formed from the left end of the edge, and the inclined surface 1206 is formed from the right end of the edge. At the edge, a connecting portion 1208 is formed which is slanted from the right end of the first abutment portion 318a toward the left end of the inclined surface 1206 and connects the first abutment portion 318a and the inclined surface 1206. The connecting portion 1208 is slanted so as to form an obtuse angle to the inclined surface 1206.

With this configuration, by moving a document placed on the document placement surface 308a leftward and forward, the front edge is brought into abutment with the first abutment portion 318a and the left edge is brought into abutment with the second abutment portion 318b. To take a document in abutment with the first and second abutment portions 318a and 318b off the document placement surface 308a, the document is moved rightward to such a position as to overlap the inclined surface 1206 in the X direction, and then moved forward. In this way, the document is slid over the inclined surface 1206 and taken off without interference with the first abutment portion 318a. As described above, the rear edge 1206a of the inclined surface 1206 is situated lower than the document placement surface 308a. Thus, by simply moving a document placed on the document placement surface 308a toward the front side, the document can be smoothly moved to the inclined surface 1206 from the document placement surface 308a.

Incidentally, while the lengths of the first abutment portion 318a and the inclined surface 1206 in the X direction can be set as appropriate, the first abutment portion 318a is formed shorter than the inclined surface 1206 in the present embodiment. This is because the fixed reading mode is intended for small documents, and these documents can be positioned well enough in the Y direction by the first abutment portion 318a even with the shorter length. On the other hand, making the length of the inclined surface 1206 longer makes it easier to take a document off the document placement surface 308a without having to widely open the ADF 16, for example.

(Positions in ADF 16 where Signal Cable and Driving Motor are Disposed)

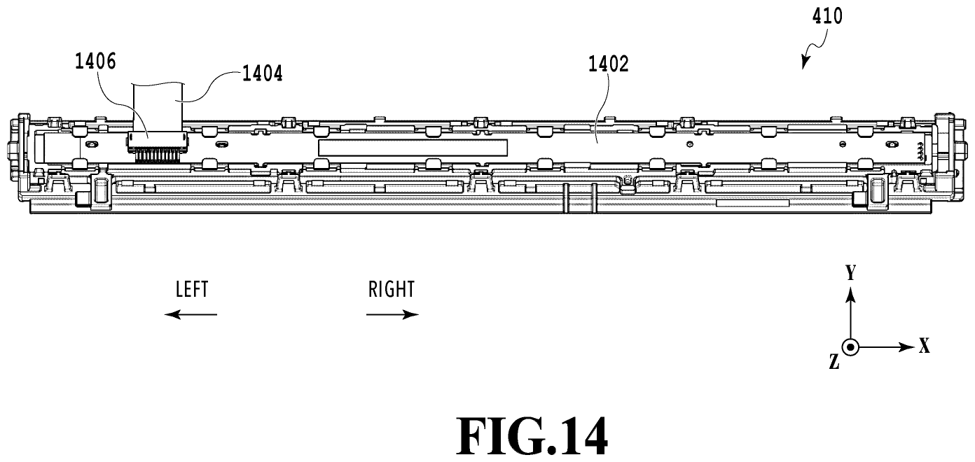

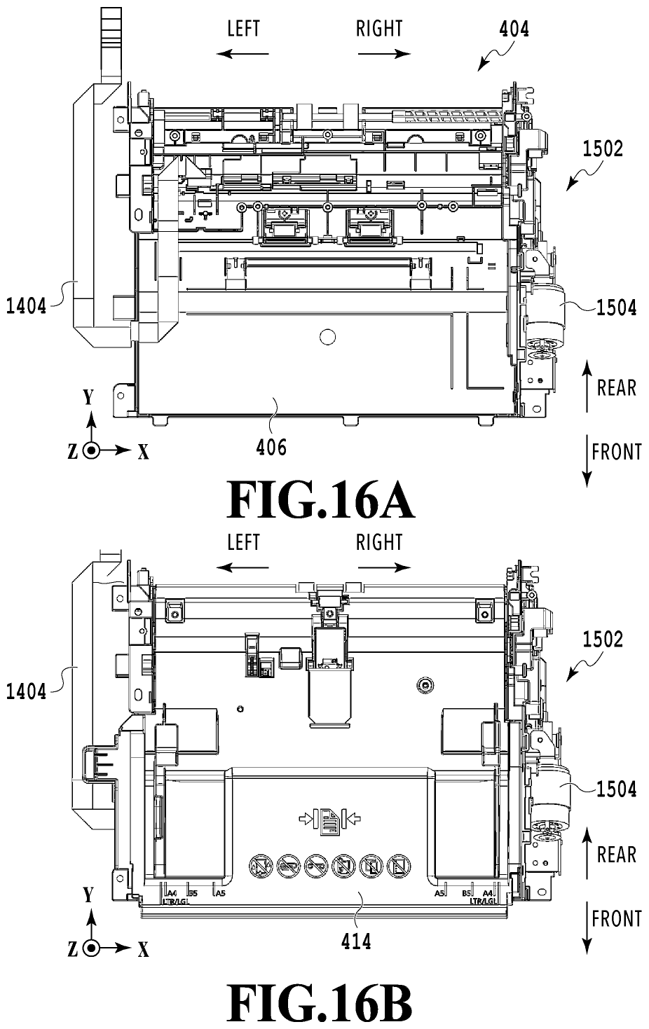

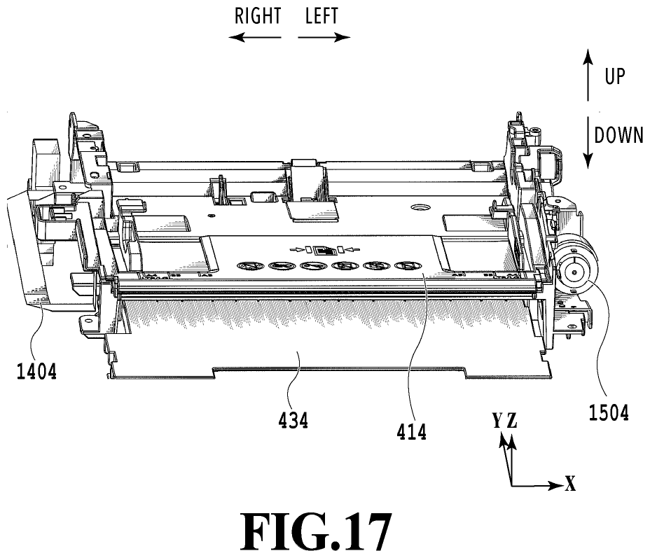

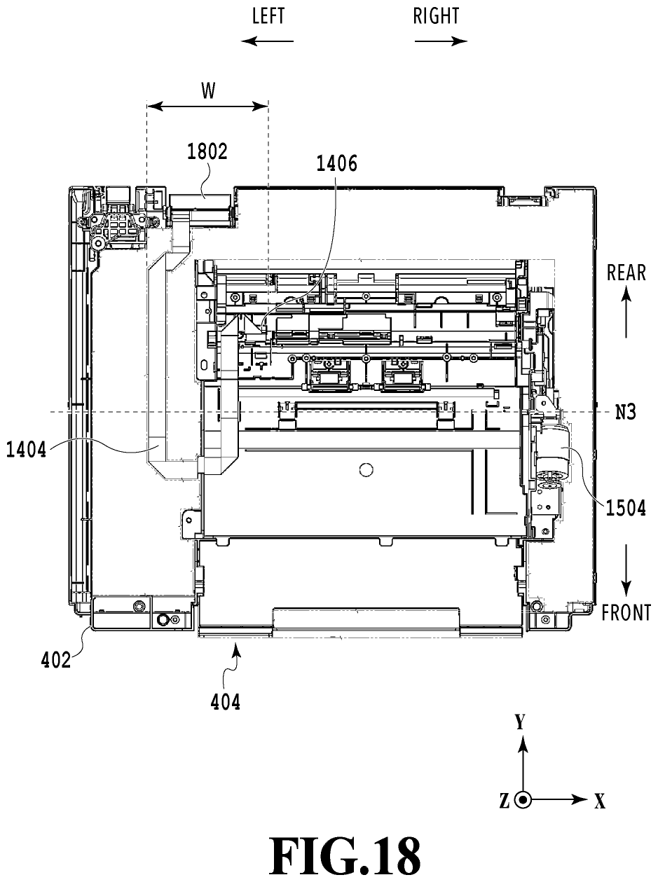

Next, a description will be given of an arrangement of a signal cable for transferring motive power and signals such as read image signals between the back surface reading unit 410 of the ADF 16 and the control part (not illustrated) of the image reading apparatus 10, and the position where a driving motor that drives the document feed part 408 of the ADF 16 will be described. FIG. 14 is a schematic view of a configuration of the back surface reading unit 410. Note that FIG. 14 is a view of the back surface reading unit 410 as seen from the opposite side from the side for reading the images on documents. FIG. 15 is a view illustrating the position on the main frame 406 where a signal cable 1404, a driving motor 1504, and the back surface reading unit 410 are disposed. FIGS. 16A and 16B are plan views of the main frame unit 404. FIG. 16A illustrates a state where the document feed tray 32 is detached. FIG. 16B illustrates a state where the document feed tray 32 (main body tray 414) is attached. FIG. 17 is a view illustrating the positional relationship between the main frame unit 404 and the discharge support surface 434 of the document discharge tray 34. FIG. 18 is a view illustrating a state where the main frame unit 404 is disposed in the housing 402 of the ADF 16.

The back surface reading unit 410 includes an image reading sensor 1402 for reading the images on documents and a connecting portion 1406 to which is connected the signal cable 1404 capable of supplying motive power to the image reading sensor 1402 and other similar operations (see FIG. 14). One end of the signal cable 1404 is connected to the connecting portion 1406, and the other end is connected to the control part. The control part receives an image signal read by the back surface reading unit 410 through the signal cable 1404. The control part also supplies motive power to the back surface reading unit 410 through the signal cable 1404. In other words, the control part in this case serves as a power supply that supplies motive power to the back surface reading unit 410.

The back surface reading unit 410 is disposed on the lower surface of the main frame 406 with the document reading surface of the image reading sensor 1402 facing substantially downward (see FIG. 15). The signal cable 1404 is routed inside the ADF 16 and also routed on the main frame 406, on which the driving part 1502 for driving the document feed part 408 is disposed. The driving part 1502 includes the driving motor 1504 as a driving source (see FIG. 15).

On the main frame unit 404, the signal cable 1404 is routed at and near the left end of the main frame 406, and the driving part 1502 is disposed at the right end of the main frame 406 (FIGS. 16A and 16B). On the main frame 406, the driving motor 1504 is located on the front side of the driving part 1502.

The region where the signal cable 1404 is routed is the rear side of the main frame 406. In addition to a region including the left end of the main frame 406 and its periphery, the signal cable 1404 is also routed on the outside of the main frame 406 (see FIG. 16A). The discharge support surface 434 is located under the position where the main body tray 414 of the main frame 406 is disposed (see FIG. 17). A document placed on the document feed tray 32 including the main body tray 414 is fed by the document feed part 408 from the front side to the rear side, turned around and transferred from the rear side toward the front side through the conveyance path 424, and discharged onto the document discharge tray 34 including the discharge support surface 434.

In sum, in the present embodiment, in the ADF 16, the signal cable 1404 is disposed on one side in the X direction, and the driving motor 1504 is disposed on the other side (opposite end) in the X direction. Moreover, in the ADF 16, although partly overlapping the signal cable 1404, a document conveyance route is located between the position where the signal cable 1404 is disposed and the position where the driving motor 1504 is disposed. In other words, in the present embodiment, the signal cable 1404 and the driving motor 1504 are disposed away from each other by the length of the conveyance route in the X direction (substantially by the length of an A4 sheet in its transverse direction in the present embodiment). This eliminates or reduces the effect of a noise originating from the driving motor 1504 on the signal cable 1404, specifically, the effect of the noise on the signals transferred through the signal cable 1404. This in turn prevents the occurrence of image defects in reading results due to the effect of the noise.

One end of the signal cable 1404 is connected to the connecting portion 1406 provided to the back surface reading unit 410, and the other end is connected to the control part through a communication portion 1802 provided near a portion to be connected to one of the hinge portions 314 located on the rear side of the housing 402 (see FIG. 18). The communication portion 1802 is formed such that the signal cable 1404 can be inserted therethrough. Thus, the signal cable 1404 connected to the connecting portion 1406 is connected to the control part through the communication portion 1802. That is, the communication portion 1802 is configured to communicate with the side where a member to be connected to the back surface reading unit 410 by the signal cable 1404 is present.

The communication portion 1802 is provided near the left hinge portion 314 located within a range W in the X direction within which the signal cable 1404 is routed in the state where the main frame unit 404 is disposed on the housing 402. Also, in the state where the main frame unit 404 is disposed on the housing 402, the connecting portion 1406 is located rearward of a center position N3 of the ADF 16 in the Y direction. Thus, the connecting portion 1406 and the communication portion 1802 are located relatively close to each other. This makes it possible to shorten the length of the signal cable 1404. Shortening the signal cable 1404 reduces the effect of the noise on the signals transferred through the signal cable 1404.

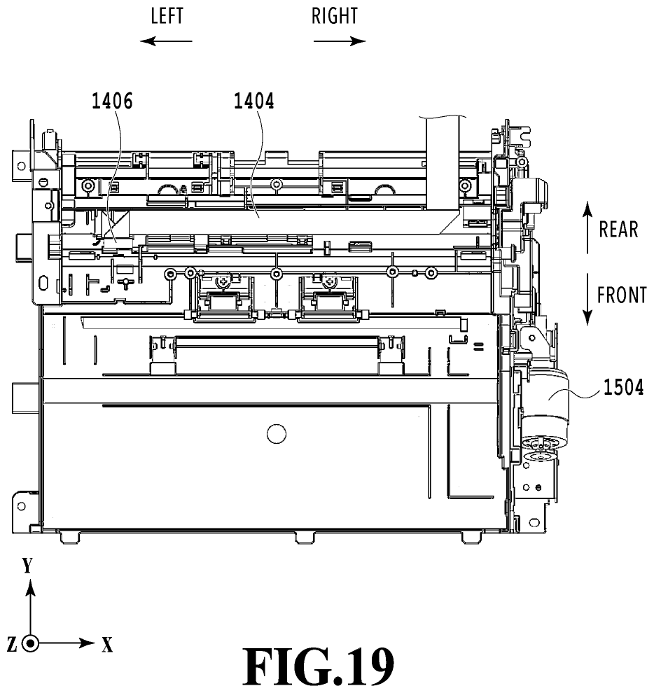

Note that the position of the communication portion 1802 is not limited to the vicinity of the portion to be connected to the left hinge portion 314, and may be provided near the portion to be connected to the hinge portion 314. In this case, the signal cable 1404 is, for example, routed along the X direction from the connecting portion 1406 and then along the Y direction from such a position as to overlap the communication portion 1802 in the X direction (see FIG. 19). FIG. 19 is a view illustrating a modification of the arrangement of the signal cable 1404. In this case, the positions where the signal cable 1404 and the driving motor 1504 are disposed are somewhat close to each other in the X direction. Nonetheless, the signal cable 1404 and the driving motor 1504 are far from each other in the Y direction (see FIG. 19). This eliminates or reduces the effect of the noise originating from the driving motor 1504 on the signals transferred through the signal cable 1404.

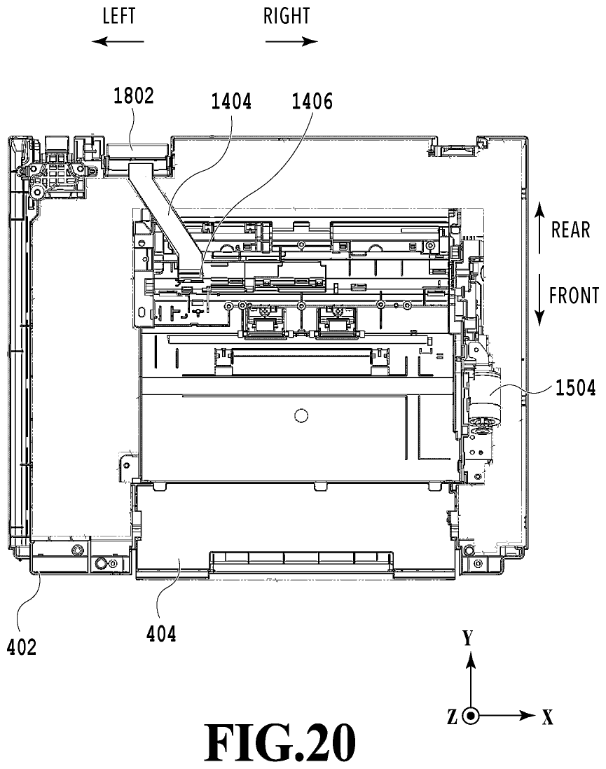

In the above description, the signal cable 1404 is routed forward from the connecting portion 1406, then routed leftward, and thereafter routed rearward on the outside of the main frame unit 404 up to the communication portion 1802 (see FIG. 18). The signal cable 1404 is not limited to this arrangement. For example, the signal cable 1404 may be routed substantially straight from the connecting portion 1406 to the communication portion 1802, that is, routed to extend along the shortest way from the connecting portion 1406 to the communication portion 1802, as illustrated in FIG. 20. FIG. 20 is a view illustrating a modification of the arrangement of the signal cable 1404. Routing the signal cable 1404 substantially straight between the connecting portion 1406 and the communication portion 1802 makes the length of the signal cable 1404 shortest. This more reliably reduces the effect of the noise on the signals in the signal cable 1404.

### Advantageous Effects

As described above, the image reading apparatus 10 is configured such that the front side of the apparatus is where a sheet on which an image has been formed is discharged, a document to be fed by the ADF 16 is placed, and a document after its image is read by the ADF 16 is discharged. Also, the cassette 22 housing sheets for printing is configured to be capable of being inserted into and drawn from the front surface (front) of the apparatus, and the sub tray 416 of the document feed tray 32 is configured to be slidable at the top of the apparatus. Moreover, the gripping portion 316 for the user to grip to open and close the ADF 16 is formed in the front surface of the ADF 16. Furthermore, the first abutment portion 318a for positioning a document placed on the platen glass 308 in the Y direction is placed on the front side of the platen glass 308. In this way, the space required to use the image reading apparatus 10 can be smaller than otherwise. This prevents a deterioration in the operability of the image reading apparatus 10 for the user even in a case where the image reading apparatus 10 is installed in a narrow space.

Also, the gripping portion to be gripped to draw the sub tray 416 serves also as the gripping portion to be gripped to open and close the ADF 16. Moreover, the configuration is such that the sub tray 416 is retained in the first position, which is its retracted position, to prevent the sub tray 416 from being unintentionally drawn. In this way, the user can use a single gripping portion to move the sub tray 416 and to open and close the ADF 16 without unintentionally moving the sub tray 416. Furthermore, in the state where the sub tray 416 is in the first position, the second support surface 416a of the sub tray 416 is substantially flush with the upper surface 402a of the housing 402 of the ADF 16. In this way, the upper surface of the image reading apparatus 10 can be used as a place to put documents and the like.

Also, the first abutment portion 318a and the inclined surface 1206 are formed at the front edge of the platen glass 308 so as to extend in the X direction. In this way, a document on the document placement surface 308a can be easily positioned by moving the document toward one side in the X direction and also moving it toward the front side. Moreover, the positioned document can be easily taken out by way of the inclined surface 1206 by moving the document toward the other side in the X direction and then moving it toward the front side.

Also, in the ADF 16, the signal cable 1404 is routed on the left side of the back surface reading unit 410, and the driving motor 1504 is disposed on the right side of the back surface reading unit 410. Moreover, a document conveyance route is located between the signal cable 1404 and the driving motor 1504. In this way, the signal cable 1404 is routed at a position far from the driving motor 1504, thus eliminating or reducing the effect of the noise originating from the driving motor 1504 on the signals in the signal cable 1404. This prevents the occurrence of image defects in reading results.

### OTHER EMBODIMENTS

Note that the above embodiment may be modified as described in (1) to (4) below.

(1) In the above embodiment, the image reading apparatus 10 has an image reading function and an image forming function, but the image reading apparatus 10 is not limited to this configuration. It suffices that the image reading apparatus 10 have at least the image reading function, and the image reading apparatus 10 may have functions other than the image forming function.

(2) In the above embodiment, the three examples of the arrangement of the signal cable 1404 in FIGS. 18 to 20 have been described, but the arrangement is not limited to these examples. As long as the signal cable 1404, which is routed from the connecting portion 1406 located on the rear left side of the document conveyance route, is routed far from the driving motor 1504, which is located front right side of the conveyance route, the signal cable 1404 may be routed in any way.

(3) In the above embodiment, the driving part 1502 is provided to the main frame unit 404, but the configuration is not limited to this one. The driving part 1502 and the main frame unit 404 may be disposed as separate members in the housing 402. Moreover, in the case of routing the signal cable as illustrated in FIG. 18 or 20, the driving motor 1504 may be disposed on the rear side of the driving part 1502.

(4) The above embodiment and the above various configurations described in (1) to (3) may be combined as appropriate.

The disclosure of the above embodiment includes the following configuration and method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-057732, filed Mar. 31, 2023, which is hereby incorporated by reference wherein in its entirety.

What is claimed is:

1. An image reading apparatus comprising:
a conveyance unit configured to convey a document in a conveyance direction through a conveyance route;
a first reading unit configured to read an image on the document conveyed by the conveyance unit;
a cable routed on one side of the first reading unit and connected to the first reading unit; and
a driving unit that is disposed on another side of the first reading unit and drives the conveyance unit.

2. The image reading apparatus according to claim 1, wherein
the first reading unit extends in a direction crossing the conveyance direction, and
the cable is routed on one side in an extending direction in which the first reading unit extends, and the driving unit is disposed on another side in the extending direction.

3. The image reading apparatus according to claim 1, wherein a region where the cable is routed and a position where the driving unit is disposed are located with the conveyance route interposed therebetween in a direction crossing the conveyance direction.

4. The image reading apparatus according to claim 2, wherein a connecting portion of the first reading unit to be connected to the cable and a communication portion of the first reading unit into which the cable is insertable and which communicates with a side where a member to be connected to the first reading unit by the cable is present, are disposed on the one side in the extending direction.

5. The image reading apparatus according to claim 4, wherein the member is a power supply that supplies motive power to the first reading unit.

6. The image reading apparatus according to claim 4, wherein the cable is routed straight between the connecting portion and the communication portion.

7. The image reading apparatus according to claim 2, wherein
the cable and the driving unit are provided to a frame including the conveyance unit and the conveyance route, and
the cable is disposed at and near an end of the frame on the one side in the extending direction, and the driving unit is disposed at an end of the frame on the other side in the extending direction.

8. The image reading apparatus according to claim 7, wherein the cable is routed on an outside of the frame in the extending direction.

9. The image reading apparatus according to claim 1, wherein a connecting portion of the first reading unit to be connected to the cable is disposed on one side in the conveyance direction, and the driving unit is disposed on another side in the conveyance direction.

10. The image reading apparatus according to claim 2, wherein a center of the conveyance route in the extending direction is located closer to the other side than a center position of the image reading apparatus.

11. The image reading apparatus according to claim 1, further comprising:
a platen including a first glass on which a document is placeable, and a second glass over which a document conveyed by the conveyance unit passes, the first glass and the second glass being arranged next to each other in the conveyance direction; and
a second reading unit capable of moving in the conveyance direction and performing first reading and second reading, the first reading being an operation in which the second reading unit reads an image on a first surface of a document placed on the first glass of the platen while moving in the conveyance direction, the first surface being in abutment with the first glass, the second reading being an operation in which the second reading unit stays at a position corresponding to the second glass of the platen and reads an image on a second surface of a document passed over the second glass by the conveyance unit.

12. The image reading apparatus according to claim 1, further comprising:
a second conveyance unit configured to convey a print medium; and
an image forming unit configured to form an image on the print medium conveyed by the second conveyance unit.

13. The image reading apparatus according to claim 12, wherein
the conveyance unit conveys a document from one side to another side in the conveyance direction and discharges the document after the reading from the other side to the one side, and
the second conveyance unit discharges a print medium after the image forming from the other side of the conveyance unit toward the one side.
